(19) United States
(12) Patent Application Publication
(10) Pub. No.: US 2005/0086257 A1
(43) Pub. Date: Apr. 21, 2005

(54) Item tracking, database management, and relational database system associated with multiple large scale test and assessment projects

(75) Inventor: Lonnie Glen Wright, Hooksett, NH (US)

Correspondence Address: MAINE & ASMUS, 100 MAIN STREET, P O BOX 3445, NASHUA, NH, 03061-3445, US

(73) Assignee: MEASURED PROGRESS, INC., Dover, NH (US)

(21) Appl. No.: 10/966,718

(22) Filed: Oct. 15, 2004

Related U.S. Application Data
(60) Provisional application No. 60/512,222, filed on Oct. 17, 2003.
(60) Provisional application No. 60/512,152, filed on Oct. 17, 2003.

(51) Int. Cl. G06F 17/00

(52) U.S. Cl. 707/103 R

(57) ABSTRACT

A system and process includes: a relational database that has a core database of global rules and project data, an item tracking database, a scanning and image management database, and a scoring database; an enterprise integrated application software program and computer network; and a web interface linking host operations and users; all of which is used for generating a production order and packing schedule of test documents from the rules and project data, for tracking production, packing, shipping, return shipping, and processing of actual test documents by using unique identifiers assigned to every document and monitoring and recording every movement of every document and appending all records of movement and other changes of condition to the original project data in the relational database, for scanning all documents into image form and storing and scoring the images, and for generating reports based on the scores and demographics of the testees.

### RELATED APPLICATIONS

This application claims the benefit of U.S. Provisional Applications Nos. 60/512,222, filed Oct. 17, 2003, and 60/512152, filed Oct. 17, 2003, which are incorporated herein in their entirety by reference.

### FIELD OF THE INVENTION

The invention relates to document production and data management systems and processes, and more particularly, to a system and process for monitoring the production, distribution, use, collection, and post-use reviewing of controlled documents and associated data.

### BACKGROUND OF THE INVENTION

There is a strong motivation across public and private sectors to find more effective ways to evaluate and compare the performance of school systems and other public and private institutions and enterprises in order to identify and distinguish the more successful schools and organizations from the less successful at meeting their common goals. There is particular interest in testing the individual students or members of the organizations to assess in the aggregate their degree and level of competence and skill as a fundamental indicator of the school or organization's overall performance.

For example, in the United States, it has been mandated that states conduct universal testing of all students within their school systems for comparative assessment of their schools. The school assessments are published so that the public through its state and school bureaucracies is able to initiate changes to improve the underperforming schools. Such testing projects, extending to tens of thousands of students, are immense undertakings, the results of which can have far reaching consequences.

At the same time, the rights of individual students require that their individual performances be kept confidential, so as not to introduce or cause prejudice at the individual level. Furthermore, there is a great need for public confidence in the integrity of the overall process, in order for its results to be meaningful. With these compelling dual requirements to maintain the confidentiality of individual results and public confidence in the result of the group assessments, the organizing and conducting of a process for creating, distributing, testing, collection, and assessment of suitable test materials, where each critical item of test materials is uniquely identified and tracked throughout the process and a complete audit trail or history is available to validate the assessment results, assuring the requisite security to protect individual performances from unauthorized disclosure, and integrity of the overall process, is a significant challenge. Add to this the need to be able to retrieve a particular student's test results when an occasional post assessment inquiry requirements it, including all test items exactly as presented and responses exactly as given, and the challenge is further heightened.

As a simplified starting point to set out the context for both the present state of the art and the invention, assume there to be a collection of groups and subgroups such as a state having school districts, which have schools, which have grade levels, of which there may be multiple classes at any level. Each class at each grade level is composed of individual students or testees. The objective of the school system, universally applicable to each district and school, and proportionally applicable at each grade level, is to educate the students in the selected subject areas to the respective grade level; in other words, to instill a demonstrably acceptable level of a common body of knowledge and associated skills.

The next condition is the emergence of a public interest in comparing the schools and districts, even down to the grade level, prompted in part by a recognized disparity in the competence level and skill of students from different schools. This interest has resulted in federally mandated testing requirements with which those in the industry are very familiar.

Other large institutions and enterprises will have analogous situations in which the competence and skill level of individuals is an important indicator of group and subgroup performance, and where management or some third party organization may have an interest in conducting a similar test and assessment scheme.

Educational consultants and other competitors in the test and assessment industry typically amass their own databases of common knowledge, and subdivide it into overlapping ranges of complexity roughly correlating expectations of age and grade level. Test materials are then prepared and shipped to the participating schools within client school system where the tests are administered by teachers to the students. The materials are then collected and returned for scoring of each student's performance and compilation of the results into grade level and school level performance parameters and reports for comparative analysis by the client states.

The cost, efficiency of administration, flexibility in numbers of students participating, integrity of the process, integrity of the final overall assessment product, as well as the degree of protection afforded the individual test taker, are some of the criteria by which various test and assessment options are evaluated by perspective client states. More particularly, clients want to see demonstrable measures taken to assure precise control over the project and testee data, and the document production, distribution, collection and scoring process, and security of the documents containing test items and/or student answers.

For all of these reasons, there is a continuing need for improved systems for conducting and monitoring test and assessment projects of this type.

What is needed, therefore, are improved techniques for tracking critical documents and data throughout the course of such large scale assessment projects, and responding to changes in the production requirements, so as to reduce the likelihood of errors, and improve the reliability and efficiency of the process.

### SUMMARY OF THE INVENTION

The Applicant has developed a unique and comprehensive system and process for educational test and assessment and other similar or analogous applications, utilizing up to date technology and techniques that can be fairly characterized as a fully integrated enterprise system. The information shared throughout its intranet and internet e-commerce trust infrastructure use best-in-practice cryptography, digital signature technology and applied 128-bit SSL (Secure Sockets Layer), which provide the authentication, data integrity and privacy necessary for e-commerce. The integrated enterprise is a real time system, scalable and modular in design for flexibility in capacity. A current embodiment of the associated computer system operates on Microsoft SQL server 2000/2003 net framework. The system database architecture is designed on a SQL server federation style with Distributed Partitioned View (DPV) partitioned horizontally. This design accommodates easily the required performance needs for a growing enterprise and B2B (business to business) commerce.

It is one goal of the invention to provide a unique answer to scalability transaction, enabling the processing power capacities, providing throughput and reliability as the transaction load grows from millions to hundreds of millions per month. The custom developed, high-throughput server software with load-balancing network architecture delivers a solid intranet/internet service explicitly intended for a contemporary commerce community.

Contained within the enterprise system are internally developed software/hardware solutions, which provide a comprehensive reporting functionality. Some of the developed systems are identified herein and described below in the context of a statewide project for testing all students in all schools in a particular subject area at a particular grade level. It will be appreciated that the context can vary significantly without exceeding the scope of the invention:

iCore—A master, core, or central database, a preferred embodiment of which is structured for state DOE (Department of Education) school and student enrollment for major test and assessment projects such as recently mandated by federal requirements in the United States. The software applies the established contract workflow business rules for general assessment, field tests, PTS, curriculum associates and alternate assessments. The system provides specific views based on security clearance and requirements. The database software creates the availability for import and export of data while maintaining the static structure, provides an interface with carriers, distribution centers, while recording shipment quantities. The algorithms are set to produce optimum class pack and overage quantities, reducing unnecessary waste. This software is the core of the database structure and is the hub-link to the enterprise system.

iTrack—A unique enterprise application integrated software system that tracks every document from it's conception at the host, through production, packing, distribution to and in route to testing centers (e.g. school districts, schools, private schools, military schools, trade schools, home schooling and detention systems) and the return from the test centers to the host facility. The software tracks each individually identified secure document throughout the host vendor's internal process system, to its final archival destination, maintaining a warehoused image copy of the document until its value has been exhausted. The system can identify an exact process flow location of each document at any give time throughout the life cycle of the contract. The tracking system has numerous reporting functions for internal and external users via the intranet and or Internet, with extensive built-in security. Additional enterprise sub systems and functionalities are explained further below.

It is another goal of the invention to provide a highly secure relational database and document management system and scheme, with intelligent connections to physical and electronic points of shipping, receiving and internal movement of items of interest, for tracking a very large number of interrelated physical and electronic items from conception to destruction.

It is a further goal of the invention that it function as a highly complex enterprise process occurring between a host and multiple clients, for concurrently conducting respective test and assessment projects, each client and project having several tiers and subsets of testee participants resulting in tens of thousands of interrelated items and materials requiring critical control and coordination in order to complete the projects with the requisite degree of accuracy, efficiency, and reliability.

A key aspect of the process includes assignment of client/project, and item identifiers to each controlled or secure item of material at the point of conception through production to testing to safe storage and retrieval capability for post project integrity for possible follow-up. The item identifiers are stored and logically linked in a relational database to associated other identifiers of related items such alternate forms of the same item and intermediate bundling and larger packing quantities of items such as test booklets and answer pages or documents, images of such documents, clipped images taken from page images, testing locations, scorers identifiers, and such other items and activities that facilitate corresponding to the associative hierarchy and history of the physical items of testing materials.

The relational database is controlled by an enterprise application integration software program using web-accessible applications to permit access by host operators, client users and scorers.

According to one aspect of the invention, there is a process for conducting an assessment project for a client by testing a select group of testees and processing of the test results, where the following steps, not necessarily in this order, are included.

Use of a system consisting of a document processing system, a computer network connected to the document processing subsystem and to the internet, and a multi-tier, scalable, EAI (enterprise application integration) software program associated with the document processing subsystem and the computer network; where the software program incorporates a relational database, a graphical web browser application for host and client interface, and an image processing application associated with the document processing system. The software program may employ extended markup language (XML) for electronic data interchange. The image processing application may employ a scalable image capture and image generation sub system.

Creation of a unique project identifier for the client and project in the relational database. This and all other identifiers discussed herein are created in accordance with a pre-established scheme, such that all such unique identifiers share a common pattern of formation for uniform decoding and understanding.

Registering client-specified testees in the relational database. This may be a manual process performed by the client and/or the host, but is preferably an automated Internet upload to the enterprise system conducted by a web-accessible client using its existing or specially prepared database of intended testees.

Creating in the relational database a unique answer page identifier for each answer page and a unique article identifier for each of the other articles of the testing materials for the project. Pages and sheets can be considered mutually inclusive and are used interchangeably in the description and claims.

Entering and associating the characteristics of each article including each answer page with its respective identifier in the relational database. This provides for recognizing a variety of different form types so that they can be referenced by type for production and packing as well as various retrieval, reporting, and scoring operations.

Applying the project identifier and the article identifier or page identifier to each respective article and page of the testing materials. As above, this may be an imprinting process or the affixing of a machine or visually readable tag or label, or the implantation of an RFID (Radio Frequency Identification) chip or other means of physically associating the identifier with the object in a detectable and readable manner.

Assembling the required articles and answer pages into individual test packets, sets or booklets. This is typically an automated process, but with the further restriction that all the unique identifiers for each of the objects being placed in a particular packet are likewise accumulated for the following step.

Creating a unique test packet or booklet identifier in the relational database for each test packet that was assembled. This packet identifier is now associated in the relational database with the identifier of each object in the packet. Then applying the test packet identifier in some form such as by printing or creating and affixing a visually or machine-readable label or tag to each test packet.

Creating unique document set identifiers and respective bills of material of multiple test packets appropriate to the project, and assembling the test packets into document sets and bundles of intermediate quantities called class packs or kits corresponding to the production plan.

Associating the respective answer page identifiers, article identifiers, test packet identifiers, and class pack or kit identifiers and container and pallet identifiers within the relational database.

Delivering the testing materials to the appropriate client site. This includes any conventional means of delivering documents such as by host vehicles, client vehicles, third party shippers, and so on. Preferred third party shippers provide web-accessible tracking systems for monitoring the progress of shipments from pickup to delivery. The process of the invention prefers an automated link to the third party tracking system.

Confirming within the relational database the delivery of the testing materials in accordance with the bills of materials, to the intended project location. This includes an inventory at the client site with manual or automated reading and entry of package identifiers through a web-accessible client station, received and compared by the system's software program to the identifiers in the relational database.

Conducting testing of testees by use of the test materials. This includes testing done on each registered testee, typically school students although the invention is not restricted in this regard. Testing may be done either separately or in small or large groups, concurrently or over a period of time. There is preferably a client representative or proctor monitoring the testing. Testing may include later registered testees as well, as elsewhere described. The time allowed for each testee to complete the test will be strictly controlled in all cases, and may include computer applied date/time stamps to computer entered answers, for incorporation with the test results.

Returning the testing materials to the host site after the testing is completed. This is likewise typically handled by a third party shipper that provides a web-accessible monitoring system for tracking the shipment.

Scanning the identifiers on test materials returned to the host site and matching them with identifiers in the database associated with the test materials dispatched and delivered. This is an important auditing step to insure integrity of the process, that all secure or controlled materials prepared, dispatched, received by the client, used for testing, and intended to be shipped back to the host, are finally accounted for at the point of return.

Associating an individual testee with a respective returned test packet, and creating in the database a unique testee identifier for each respective testee. Then associating each testee identifier with a document set identifier in the relational database. Testee identities and demographical data are sensitive data, and may in some cases or projects be maintained in a separate database linked to the system's relational database only by a testee identifier, and matched only after the testing and scoring are complete. Some school systems have a functional student identification system and database capable of interfacing with the system for control and security of testee information.

Scanning each page of each secure item that is other than a used answer page provides a warehouse image of these documents that can be retrieved if required to confirm its condition at the time of return, while the hardcopy can be immediately stored.

Scanning each used answer page and storing an image of it in the enterprise system precedes the all image scoring process. The paper copy is only resorted to in exceptional circumstances. Then the system creates and associates a unique image identifier in the relational database for each image.

Associating the image identifiers with the testee identifiers, answer page identifiers, article identifiers, test booklet identifiers, and document set identifiers of the project in the relational database provides an audit trail analogous to the “chain of custody” tradition of guarding evidence in legal proceedings. There is never a question about where the item is or has been.

Extracting information from answer sheets depends on whether the answers were open response items requiring human reader for effective evaluation, or OMR type answers that can be machine read with a high degree of reliability. Clipped images or full page images of open response items are visually presented to scorers for scoring. Raw scores are entered and associated in the relational database with the respective image identifiers, and hence with the answer page identifier, testee identifier, article identifier, test packet identifier, and document set identifier and project location of the project.

Further aspects of the invention provide for other useful steps and details, such as entering and associating demographic details of each testee with the respective testee identifier in the relational database if the project rules provide for it. The identifiers may be in the form of bar-codes, and the step of scanning the identifiers on returned testing materials may use laser scanning, zone optical character recognition and live video encoding (LVE) of the bar-codes on returned testing materials. The scanning of identifiers on returned test materials and scanning each answer page of each test packet may include extracting of index information from images using any of zone optical character recognition, OMR, bar code, and ICR techniques.

Multiple assessment projects may be conducted concurrently, where each project is distinguished by its unique client project identifier, both in labeling of tangible test materials as well as in the relational database.

In another aspect of the invention, presenting images visually to scorers for scoring may consist of providing controlled access to scorers at web-accessible locations for viewing the images for reading and scoring, and presenting the images in a selected sequence of images. The computer program and system may perform a caching of the next image or images in a sequence of images at a scorer's work station such that any interruption in the program or network results in the intentional lose of cached images for security purposes.

In yet another aspect of the invention, there is employed the further step of registering and testing additional testees after the testing materials are already delivered to the client site. This may required including extra test booklets in the testing materials, which have extra identifiers, at the planning and packing stage and including an allowance for extra testees in the bills of materials and materials shipped to the client; validating the identifiers on the extra test packets delivered to the client site from web-accessible locations by comparing them with identifiers of extra test packets recorded in the relational database; registering additional testees in the relational database from web-accessible locations; creating a unique additional testee identifier in the relational database for each respective additional testee; associating the additional testee identifier with a validated extra test packet identifier in the relational database; printing at the client site a corresponding identifier label for each additional testee; and attaching the identifier label to the corresponding extra test packet with which it is associated.

In still another aspect of the invention, the scanning of each answer page of each test packet and storing an image in the enterprise system may consist of clipping or extracting only designated testee response portions of the answer page images as clipped images, and storing each clipped image as opposed to a full page image.

The system may provide for the registering in the relational database client-specified testees as well as client representatives other than testees, such as proctors, administrators and scorers, from web-accessible locations remote from the host site.

An additional aspect of the invention provides for the testing materials to include demographic questions and provision for accepting testee inputs relating thereto, the software system having web-accessible capability for retrieval, review and correction of testees' demographic information by client representatives other than the testees, and the reviewing from web-accessible locations by the client representatives of the testee inputs relating to the demographic questions.

Another additional aspect of the invention includes automated reviewing of the specific answer area of the image of the answer pages associated with a respective question; with automated detecting between the presence and absence of a testee input in a specific area; automated recording in the relational database of the detected absence of a testee input associated with a respective question; automated routing to scorers of the images for which the presence of a testee input was detected; and automated withholding from scorers of the questions and associated images for which the absence of a testee input was recorded, so that the absence of an answer is treated consistently throughout the scoring process.

The document processing system and the software program may in combination have capability for automated indexing of images in the relational database according to specific attributes in order to facilitate retrieval of the images on the basis of the selected attributes. The image processing application associated with the document processing system and the software program may in combination use pipe functions where output from one command is the input for a second command, without passing the data through a keyboard or display screen.

The graphical web browser-based access tool may consist of one page user interface or “dashboard” for providing menu driven access to the relational database management system, internet and intranet communications with other users, and automated report generation.

In still another additional aspect, there may be the further steps in the process of extracting testee results from the relational database management system; and populating a pre-defined report template in specific sequence for print order automation.

The invention contemplates in the first instance, the use of all or some paper documents in the testing materials and assessment process, although it extends to paperless assessment and testing as well. The invention is susceptible of both apparatus and process descriptions. One aspect of a system for conducting at least one assessment project for a client by use of group testing of testees employing at least some paper articles or documents, is a host-operated enterprise system with a document processing system configured for making an electronic component image of each component of the testing materials provided to it, scanning a unique testing materials identifier appearing on each component of the testing materials, sorting the components in a pre-selected order, and associating each component of testing materials with its respective assessment project.

The system also has a computer network connected to the document processing system and to the internet; and a multi-tier, scalable software program associated with the computer network. The software program has an architecture consisting of a relational database, where the relational database contains a contracts master database organized by unique project designator for holding primary contract information and business rules relating to respective said assessment projects. The relational database further incorporates pre-determined business rules and algorithms common to all the projects. The software program also has a web browser-based application for host administration and user interface, incorporating an engine that matches, tracks, records, accounts for, and reports on each unique testing materials identifier associated with each component of the testing materials, as well as on a unique testee identifier associated with each respective testee. Each identifier being further associated with a respective unique project designator.

The software program also has an image processing application associated with the document processing system for scanning, imaging, processing, storing, accessing, and viewing images of the test materials. There is also a web-based access tool for providing internet access to the system by client representatives and host administrators; and a web-based access tool for access by system operators for system operation, monitoring, maintenance, and reporting.

The system may have a web-based access tool for providing internet access to client representatives and host administrators, having the capability for client enrollment verification, client representative registration, host administrator registration, ordering of additional testing materials, placing requests for picking up testing materials when testing is completed, and getting related reports.

The enterprise system may incorporate software and provisions for client site PDF (portable document format) data printing of unique testee identifier labels for attachment to respective spare test sets of testing materials, for testees registered after the shipment of testing materials according to an original testee list.

The enterprise system may have a web-based tool for access by system operators that incorporates capability for remotely configuring set up of the document processing system for conducting returned test materials processing operations, as well as for monitoring progress of document processing operations, and for monitoring status of materials received and waiting to be processed and materials already processed.

In other aspects, the testing materials of the invention have demographic questions and provision for accepting testee inputs relating thereto, and the software system may have capability for retrieval and compilation of testees' demographic information in accordance with client-specific requirements.

The document processing system and the software program may in combination have capability for automated indexing of the images for identification of selected attributes of the testing materials in order to facilitate retrieval of images having said selected attributes.

The relational database and the software program in combination may have an index address storage scheme for tracking and managing the post processing archival location and relationship of the testing materials.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is block diagram illustrating a document production, distribution, tracking, scoring, and database management system and process configured in accordance with one embodiment of the present invention.

FIGS. 2 and 2.01 are simplified block diagram depictions of the discrete touch points for data transfer within one embodiment.

FIG. 3 is a diagrammatic depiction of the system overview of the core or central database component of one embodiment.

FIG. 4 is a diagrammatic representation of the multi-tier architecture of the core or central database component of one embodiment.

FIG. 5 is a simplified logic diagram and flow chart of a process by which contract data is entered in proper format in the core or central database of one embodiment.

FIG. 6 is a diagrammatic depiction of the workflow architecture of the central document tracking system component of one embodiment.

FIG. 7 is a diagrammatic depiction of the workflow architecture of a satellite document tracking system component of one embodiment.

FIG. 8 is a diagrammatic representation of the multi-tier architecture of the central document tracking system component of one embodiment.

FIG. 9 is a simplified flow chart of the pre-kitting steps in a production process for determining the required master items of assessment materials for intermediate level assembly prior to final packing and distribution of assessment materials to project locations.

FIG. 10 is a simplified flow chart and logic diagram of the steps associated with kitting of ancillary or non-controlled master items preceding final assembly steps in the production process.

FIG. 11 is a simplified flow chart and logic diagram of the final assembly steps of packing the assessment materials for shipment to project locations.

FIG. 12 is a simplified flow chart and logic diagram of the initial steps in the shipping process whereby packed materials are consigned to a third party shipper.

FIG. 13 is a simplified flow chart and logic diagram of the primary steps in the receiving process for receiving bulk returned materials from project locations after testing.

FIG. 14 is a simplified flow chart and logic diagram of the materials organizing steps subsequent to receiving bulk returned materials and prior to logging in the document level materials.

FIG. 15 is a simplified flow chart and logic diagram of the logging in steps of document level materials, preceding the scanning preparation of secure test materials.

FIG. 16 is a simplified flow chart and logic diagram of the scanning preparation steps, gate keeping, and scanning of secure test materials, including headers, test materials identifiers, and individual answer pages.

FIG. 17 is a simplified flow chart and logic diagram of the steps for reconciling materials for which identifiers were not scanned or matched successfully to existing database information.

FIG. 18 is a simplified flow chart and logic diagram of one embodiment scanning process connecting the logging in of returned test booklets to extraction of OMR data, template driven scanning of selected answer areas for clipped images, and whole page scanning of open response answer areas, to scoring of component portions of answer documents, to compilation of raw scores to a final score.

FIGS. 19, 19.01, and 19.02 are a more detailed flow chart and logic diagram of one embodiment scanning component of the invention, extending from opening and cutting of booklets to access pages and scanning a blank booklet in this manner for creating scanning templates, to extraction of clipped images for scoring.

FIG. 20 is a diagrammatic representation of the image storage and retrieval organization and functionality of one embodiment scanning and image servicing component of the invention for scoring activities.

FIG. 21 is a simplified flow chart and logic diagram of a qualification process of readers for the scoring process and component of the invention.

FIG. 22 is a simplified flow chart and logic diagram of a regular scoring reader's workflow within the scoring process of the invention.

FIG. 23 is a simplified flow chart and logic diagram of a senior reader's workflow within the scoring process of the invention.

FIG. 24 is a simplified flow chart and logic diagram of a chief reader's workflow within the scoring process of the invention.

FIG. 25 is a simplified flow chart and logic diagram depicting the forms flow within the scoring process of the invention.

FIG. 26 is a simplified flow chart and logic diagram depicting the handling of a response marked in a wrong location within a scoring process of the invention.

FIG. 27 is a simplified flow chart and logic diagram depicting the work flow for responses designated for “read behinds” after initial scoring, within the scoring process of the invention.

FIG. 28 is simplified flow chart and logic diagram depicting the workflow and management hierarchy of a scoring system administrator within the scoring process of the invention.

FIG. 29 is a sample illustration of one embodiment test booklet template to which a static barcode identifier relating to the type document, contract, grade, content area and form number, and a unique or variable barcode item identifier with a grade and form number embedded in it, have both been affixed in pre-determined locations.

### DETAILED DESCRIPTION OF THE INVENTION

The invention is susceptible of many embodiments, as will be readily apparent to those skilled in the art. What is described and illustrated herein are preferred embodiments and are to be construed as illustrative but not limiting of the invention.

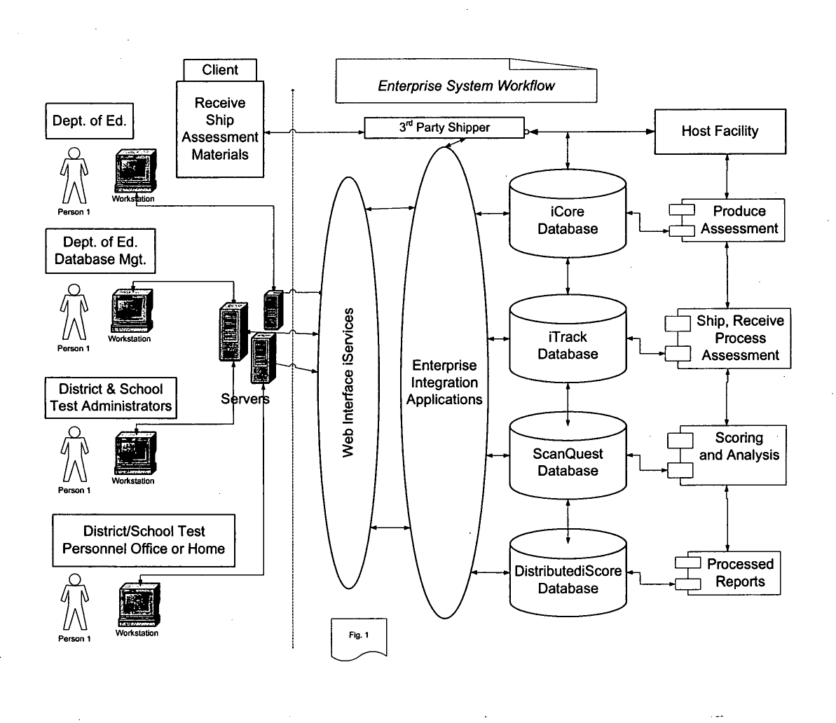

FIG. 1 is a block diagram illustrating a document production control and information handling system configured according to one embodiment of the present invention. The system of this embodiment comprises an enterprise level software application. The application comprises integrated software components providing core data management, document tracking tools, information entry, and authorized client computer access. The integrated software components each correspond to dedicated databases.

The left side of FIG. 1 depicts a multi-level client entity, which is interfaced with the system for control and coordination via the web interface iServices application. The right side of FIG. 1 depicts the physical acts with which the system is linked, including: production and packaging of the assessment materials; shipping and receiving of the assessment materials via a 3rd party shipper between the host facility and the client's project locations; scoring and analysis of the returned test materials; and the processing of client reports. The principal database components of the relational database of the system are arranged vertically down in FIG. 1 as the core or central database, the tracking database, the scanning database, and the scoring database.

According to one embodiment, the system is adapted to the production control, distribution control, monitoring, administration, scoring, and reporting of results of a large-scale assessment or test. Typically, such an assessment or test would be administered in an educational environment where a large sample of test takers are being assessed, for instance, assessments may be administered on state-wide, regional, district or school administrative unit (SAU) levels. In such an embodiment, a plurality of tiered host access points or interfaces is provided. Such access points may be via world wide computer network, Internet, Intranet, or such other suitable technology as would be known to one skilled in the art.

The host agency provides the system with parameters or global business rules. Based on these parameters, the core data management component of the application dictates the global rules by which assessment materials production, distribution, tracking, scoring, reporting, and archiving are conducted. Secure elements of the assessment materials intended to be restricted from public disclosure, including all secure test materials containing any test items or questions, are formed or marked with unique item identifiers. Identifier formats include, but are not limited to, bar codes, serial numbers, and other technologies known to those skilled in the art, whereby a identifier encoded with various client and project data, including testee data, may be entered, imprinted, or encoded onto or into an assessment article or document. An additional identifier or component of an identifier identifying the particular assessment article or document may be likewise incorporated. These identifiers permit the tracking component of the invention to monitor the location of each secure article. They are also used to associate related articles, events and data in a relational database component of the invention. For example, the article, such as a test booklet, is associated within the database with a parent article such as a bundle of spiraled booklets that includes the booklet of interest, with child articles such as a test item page or answer page of the same booklet, with the project location where the article was shipped to for the test, with the testee who used the article during the test, and with the scorer who scored each answer in the article if it included answers.

Once the project data and project rules are entered, a master items requirement and a production plan are generated, by which actual production of assessment materials is released, monitored, and controlled. Groups of assessments and other documentation are grouped according to the client parameters. Each grouping is assigned identifiers as necessary to indicate the grouping of each document. Thus by monitoring the shipment and status of each cohort or container of documents, the tracking software can, with precision, identify the location and status of a particular document, known to be contained, therein.

The system is set up to provide an infinite range of project rules which are highly specialized but afford tracking of a document from production through final disposition. Various levels of the client organization or institution may input information to the client organization's servers, which interface with the system or enterprise integration application via the Internet or other network. To facilitate this interface a web interface, such as the iServices™ interface offered by the applicant may be provided. The physical operations with which the system is interfaced, monitors, and controls, have been explained. The system interfaces and communicates with data marts containing information corresponding to various component applications of the system. These component applications then coordinate various physical functions with the data from the data marts.

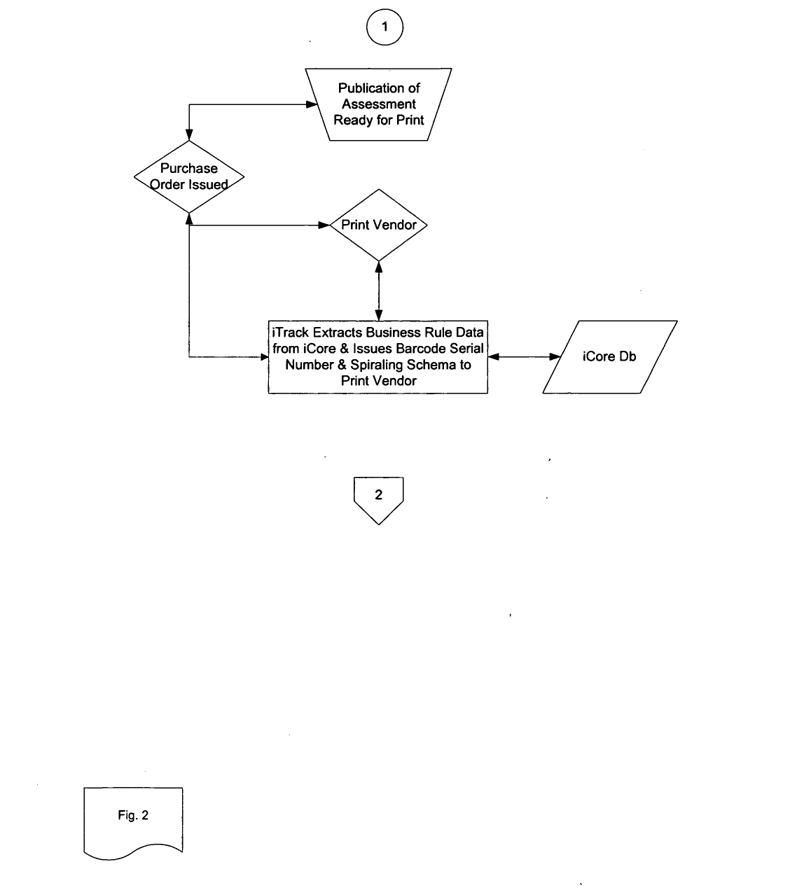

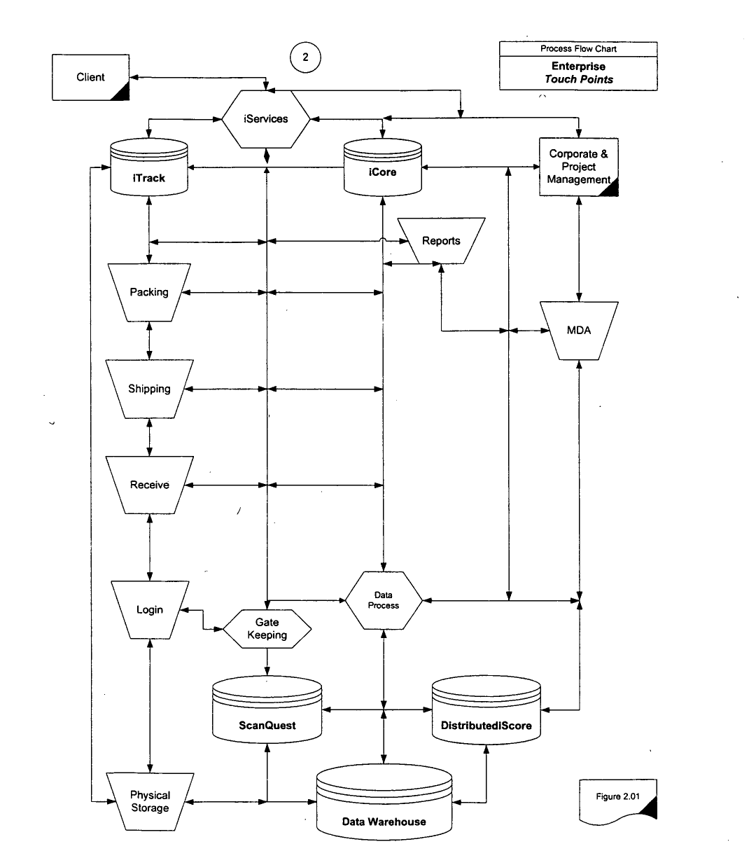

As illustrated in FIG. 2, upon loading of project data into the system and initialization of a project, purchase orders for the required quantities of all master items are generated and issued to either or both internal and external production sources. Secure item identifiers are issued in ranges according to project criteria such as the number of forms and project locations. The production sources are provided all necessary identifiers, schemas and formulae for the production and spiraling of the secure documents. The master items are then produced in the required quantities.

FIG. 2.1 is a continuation of FIG. 2 and is a simplified block diagram depiction of the discrete touch points for data transfer within one embodiment during the normal operation of the system. Integrated data marts are provided in a data warehouse where all contract information and project data is stored. Distribution of dataflow between data marts is provided by various core component applications: core, tracking, scanning, scoring, and client components. Entire operations of each of the component applications are reported in real time via the MDA (measurement design and analysis) route to management. Integration of the system provides “touchpoints” where corporate or program management can observe operations in real-time.

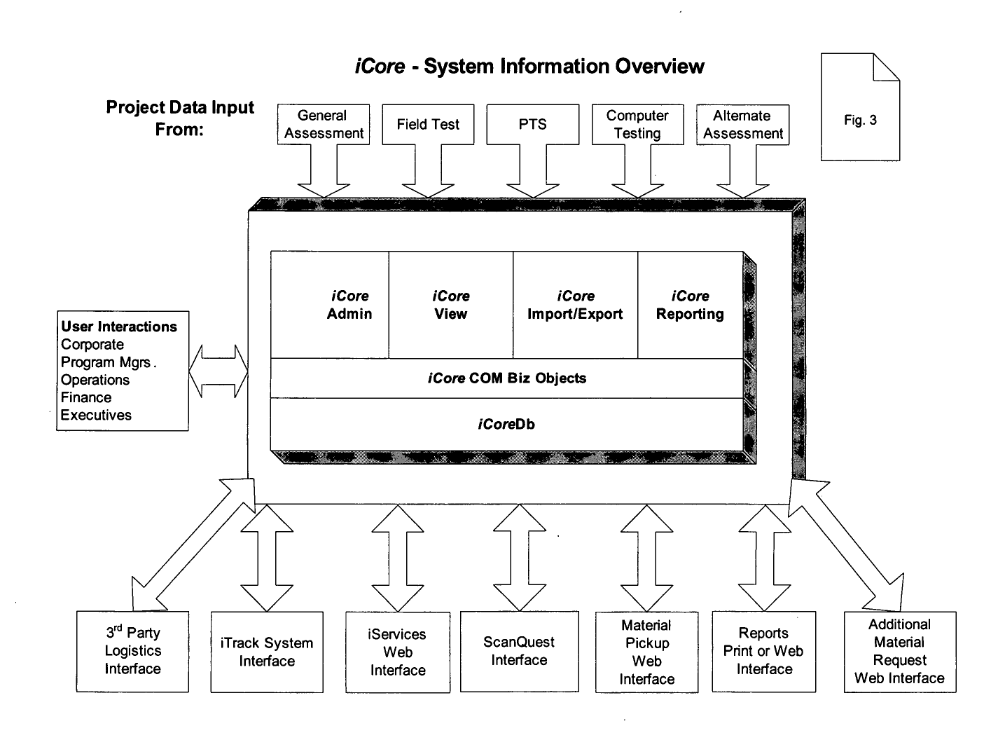

FIG. 3 is a diagrammatic depiction of the system overview of the core or central database component of one embodiment. The core or central database component provides from the top of FIG. 3 downward, various possible project data inputs such as PTS (Progress Towards Standards®) and other commercially available or published test protocols. Inputs from testing formats are categorized into COM biz objects—rules based on category. Data is then sent and received between the database and the several listed interfaces and functions at the bottom of FIG. 3, including tracking, scanning, and reports. Entry, selection or configuration of global rules applicable to the contract will define the operational parameters within which the project rules will apply. Project data can then be entered into and edited within framework established with the global rules.

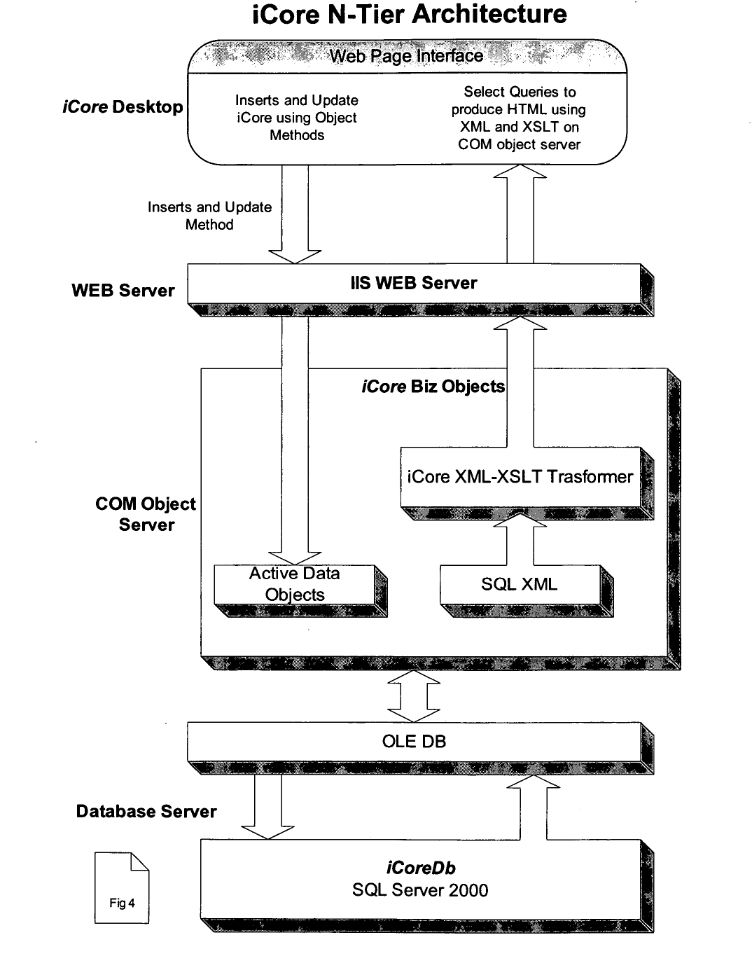

FIG. 4 is a diagrammatic representation of the multi-tier architecture of the core or central database component of one embodiment, the nature of which will be readily apparent to those skilled in the art. This format is representative of the other related database components of the system. Direct core component access is limited to host personnel. Multi-tiered architecture facilitates customization and adaptation to different and larger projects.

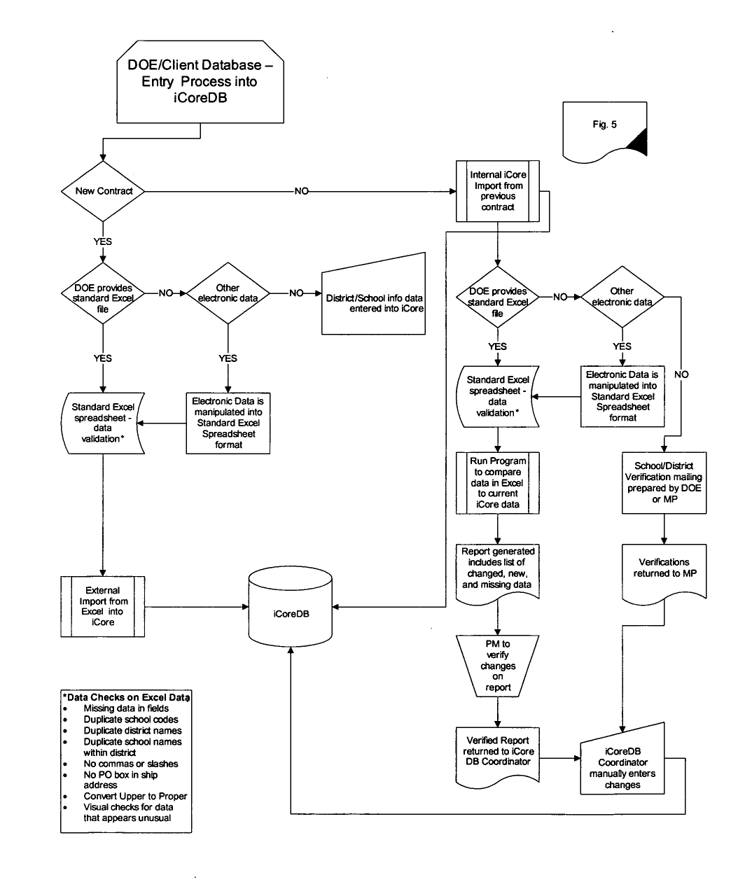

FIG. 5 is a simplified logic diagram and flow chart of a process by which contract and project data are installed in proper format in the core or central database. Where clients have compatible electronic files, for example in Excel™ format (Excel™ is a trademark of the Microsoft Corp. and no claim is made to term by the applicant.), data entry is facilitated. Previous data from the same client, where applicable, can be retrieved and used. Global rules provide for rigid “cleaning” or quality control with edits of client data as necessary to insure that initial data is organized with precision prior to acceptance. The term MP in any figure is synonymous with system host. PM indicates program manager.

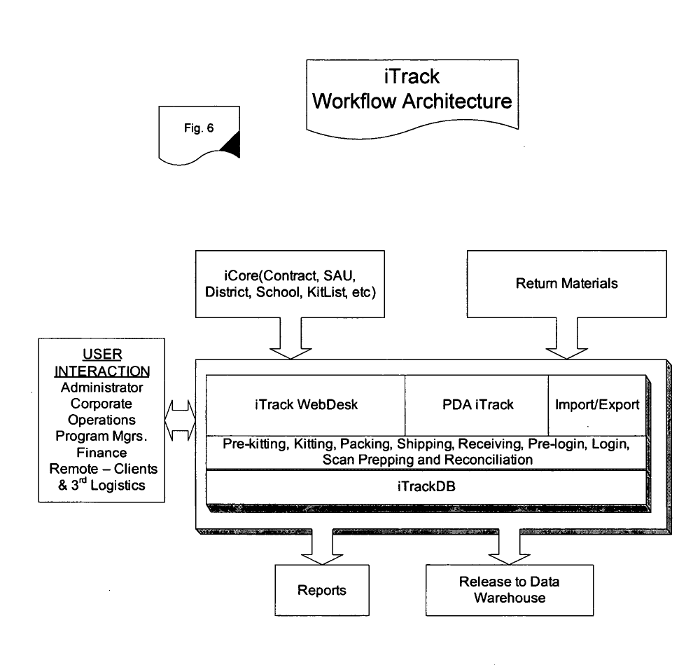

FIG. 6 is a diagrammatic depiction of the workflow architecture of the central document tracking system component of one embodiment. It is similar to the architecture of the core component as illustrated in FIG. 3, which provides a degree of commonality and assures compatibility. Icore™ data is drawn down into the iTrack™ component as needed for its functions. New and updates to existing information are uploaded and appended to existing data, so that no project data is overwritten in the iCore™ database and a full audit trail is always available.

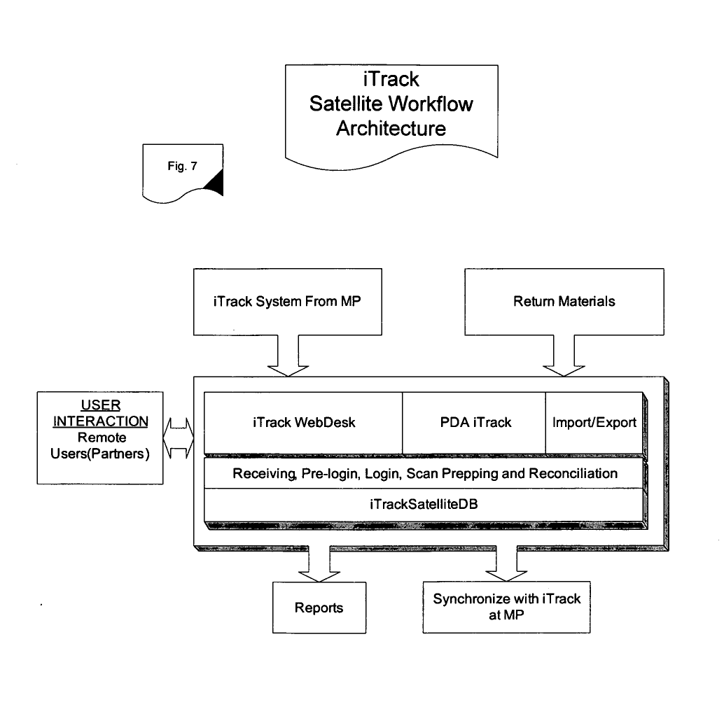

FIG. 7 is a diagrammatic depiction of the workflow architecture of a satellite document tracking system component of the system, such as would be operated at a remote or wireless site. Limited business rules and batch uploading and down loading may be necessary at least some of the time, although real time communications is always preferred. Uploads from and synchronization with satellite tracking activities are subject to continuous quality control prior to acceptance within the system.

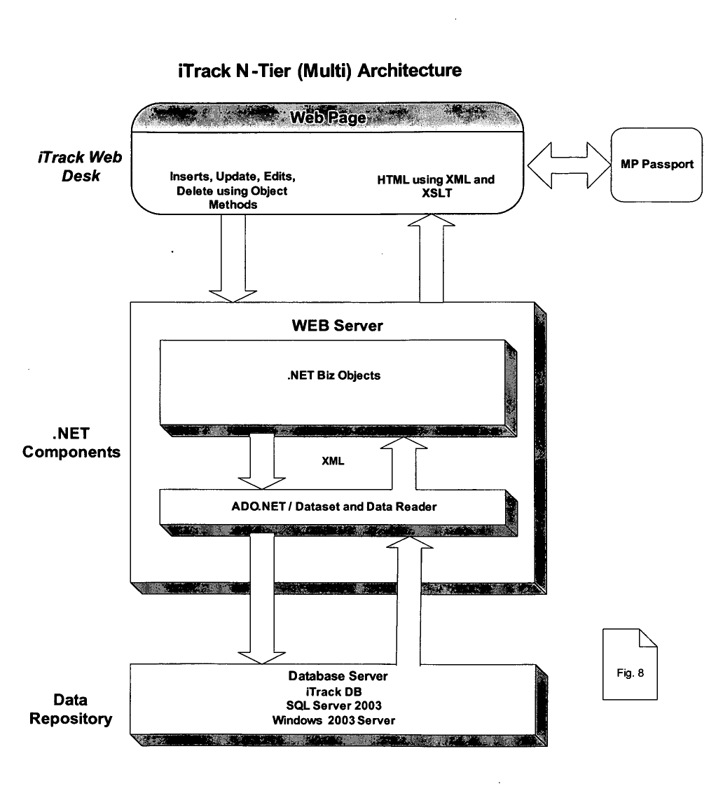

FIG. 8 is a diagrammatic representation of the multi-tier architecture of the central document tracking system component, and is clearly similar to that of the core component architecture. MP passport indicates web based user access to this component of the system.

The use of two dimensional bar codes carrying additional coded information reduce the need to access the database for initial commands and more information when reading item identifiers. They can provide command instructions for tracking actions concurrently with the reading of their identifiers. The use of RFID technologies offers similar distribution and availability of even more complex, pre-determined, in-processing, routing, set up and operating instructions for items being received, packaged with the item and inputted as commands to the system at the time and place of receiving the item identifier.

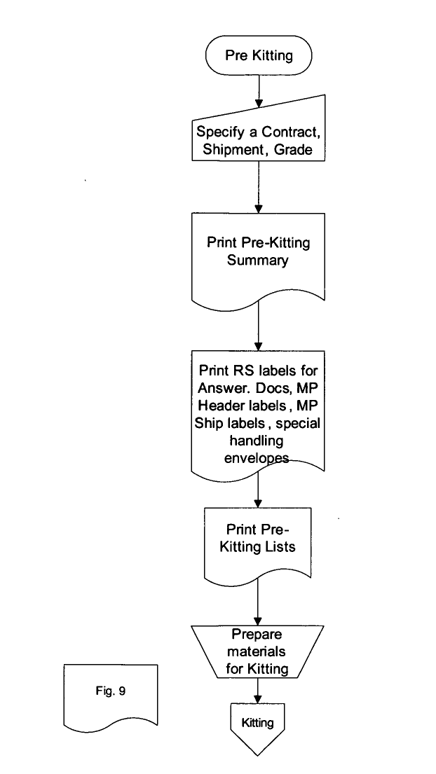

FIG. 9 is a simplified flow chart of the pre-kitting steps in a production process for determining the required master items and quantities of assessment materials, and schedule for intermediate level assembly of convenient incremental quantities as kits, prior to final packing and distribution of assessment materials to project locations. Pre-kitting establishes the order of assembly or rules for kitting. Labels including shipping labels and return shipping labels are printed for inclusion in the kits.

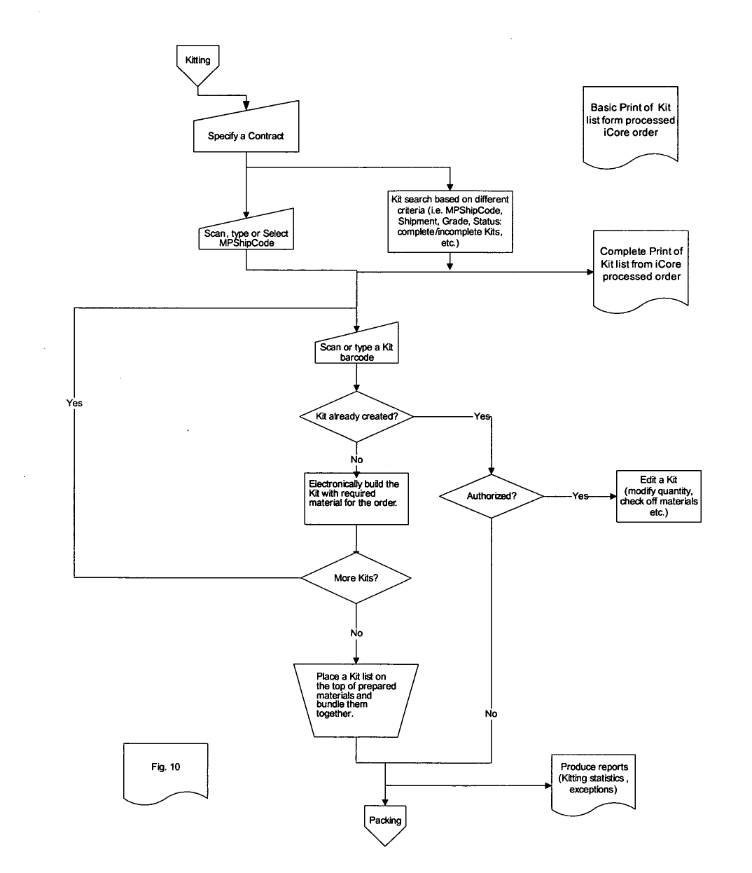

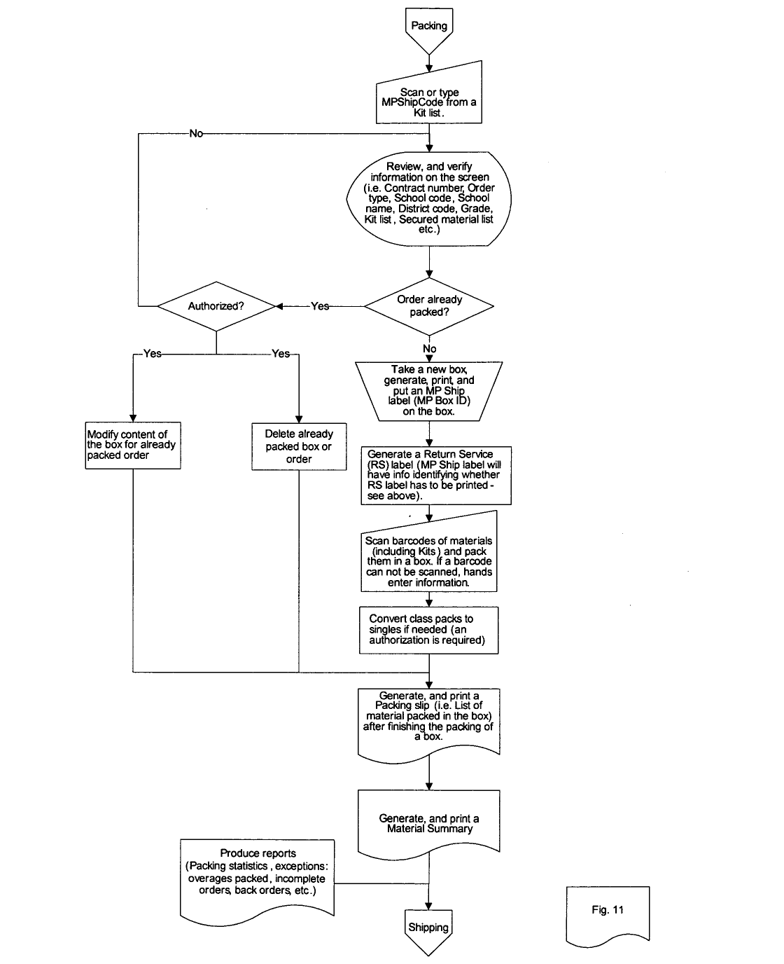

FIG. 10 is a simplified flow chart and logic diagram of the steps associated with kitting of ancillary or non-controlled master items preceding final assembly steps in the production process. Kits are virtually assembled within the system using the required master items, and a kit list of the virtual assembly is issued and used to control the matching physical assembly process. The overall packing plan from pre-kitting of master items to final packing is divided by the number of project locations into as many different packing plans, so all virtual and real assembly is defined foremost by the project location to which the shipping container is allocated.

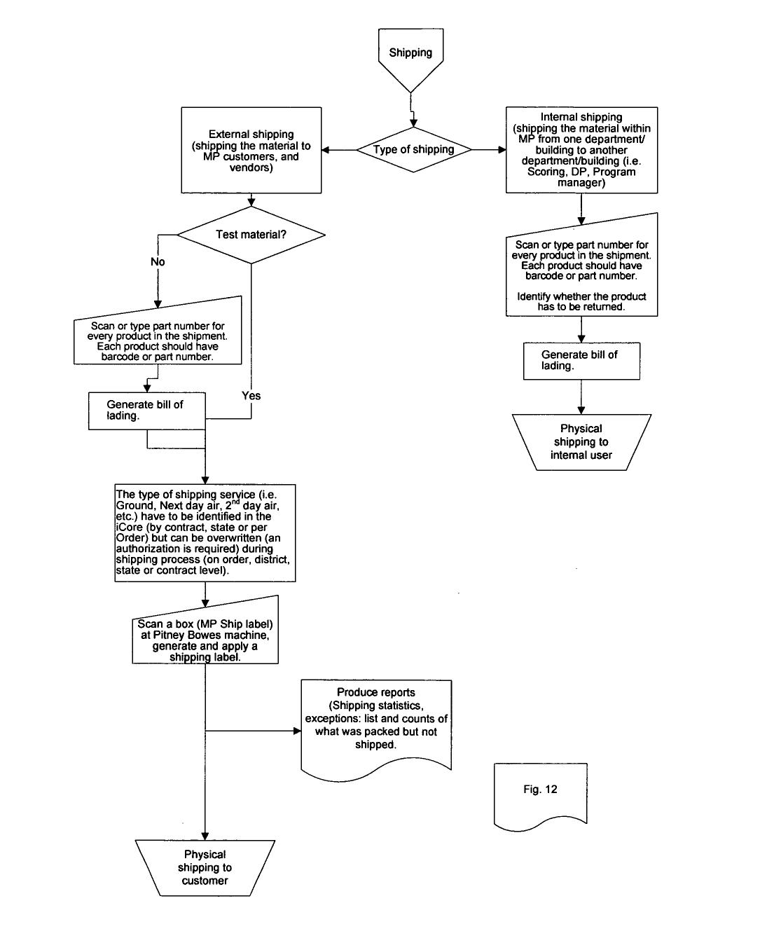

FIG. 11 is a simplified flow chart and logic diagram of the final assembly steps of packing boxes of the allocated assessment materials for shipment to a specific project location until all required materials are packed.

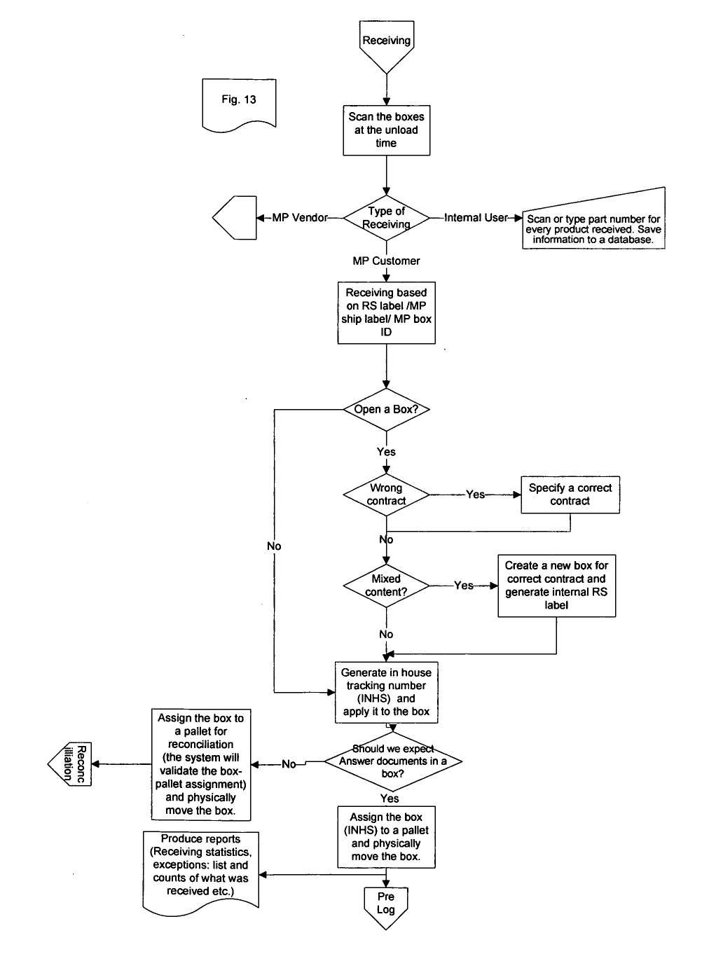

FIG. 12 is a simplified flow chart and logic diagram of the initial steps in the shipping process whereby packed materials are consigned to a third party shipper. The host container identifier is linked in the system to the shipper's container tracking number. Not shown but part of the preferred procedure is upon shipping, an email notice is sent to a point of contact at the client location that the shipment is enroute. The shipper's tracking numbers are provided, as well as a hyper-link to the shipper's on-line tracking system.

Upon receipt at the project location, the inventory is checked against the packing list down to every master item and every quantity, and a report is provided back to the host, typically via the on-line iServices component interface.

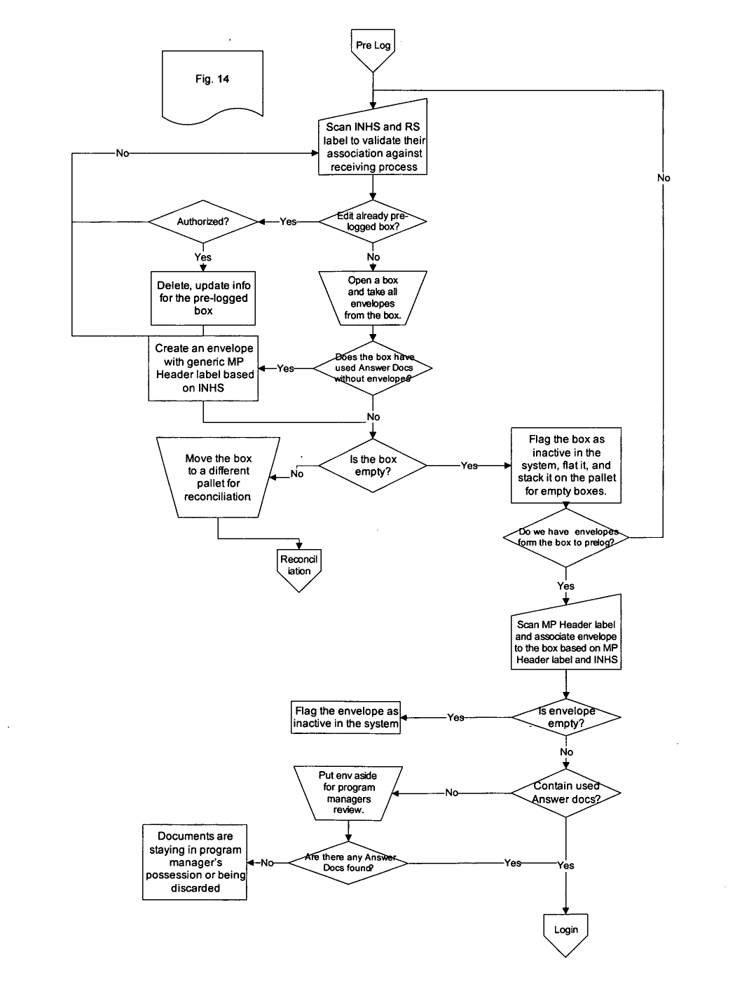

FIG. 13 is a simplified flow chart and logic diagram of the primary steps in the receiving process for receiving bulk returned materials from project locations after testing. It is initially scanned and reported on at the container or box level only, with the assumption that the box contains the expected contents according to the instructions provided to the client. Boxes may be opened and a next level item identifier checked to correlate the expected contents. Errors are corrected immediately by re-labeling all affected items, so that returned materials can continue a normal workflow through the system.

FIG. 14 is a simplified flow chart and logic diagram of the steps for handling returned materials subsequent to receiving the bulk returned materials and prior to logging in the document level materials. Intermediate level containers, typically large envelopes provided expressly for holding and returning test booklets and answer documents, are checked prior to login at the document level. This stage of handling returned materials can be characterized as the reverse of the kitting stage on the front end or assembly end of the assessment process. As at all stages, edits and corrections to the proper characterization and identification of materials are applied immediately, so as to keep all materials possible in the mainstream of the process and avoid accumulations of exceptions.

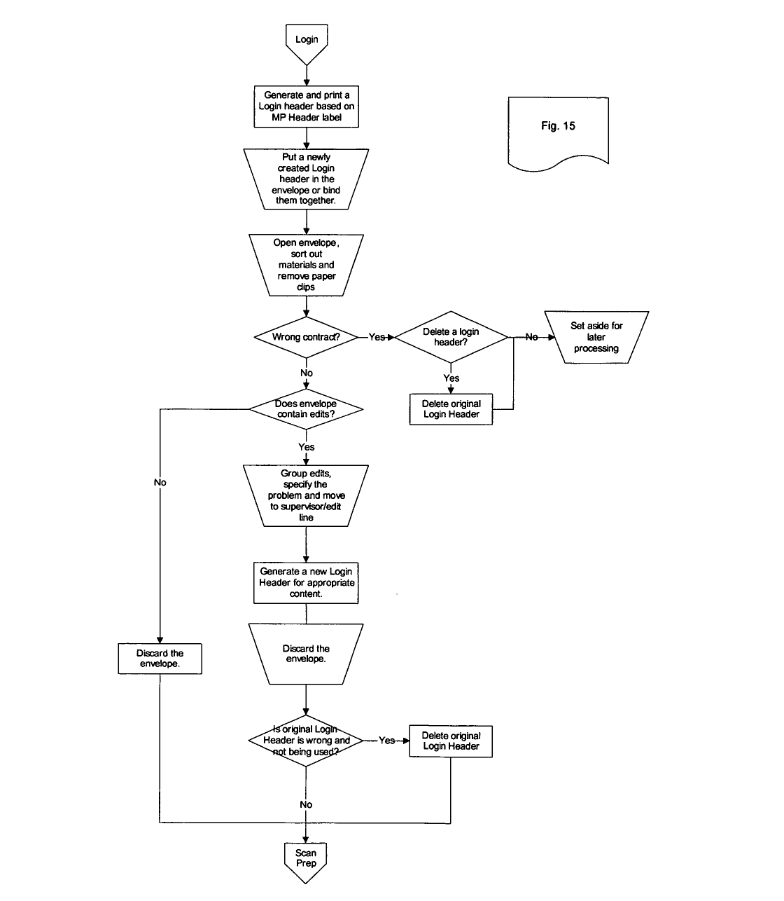

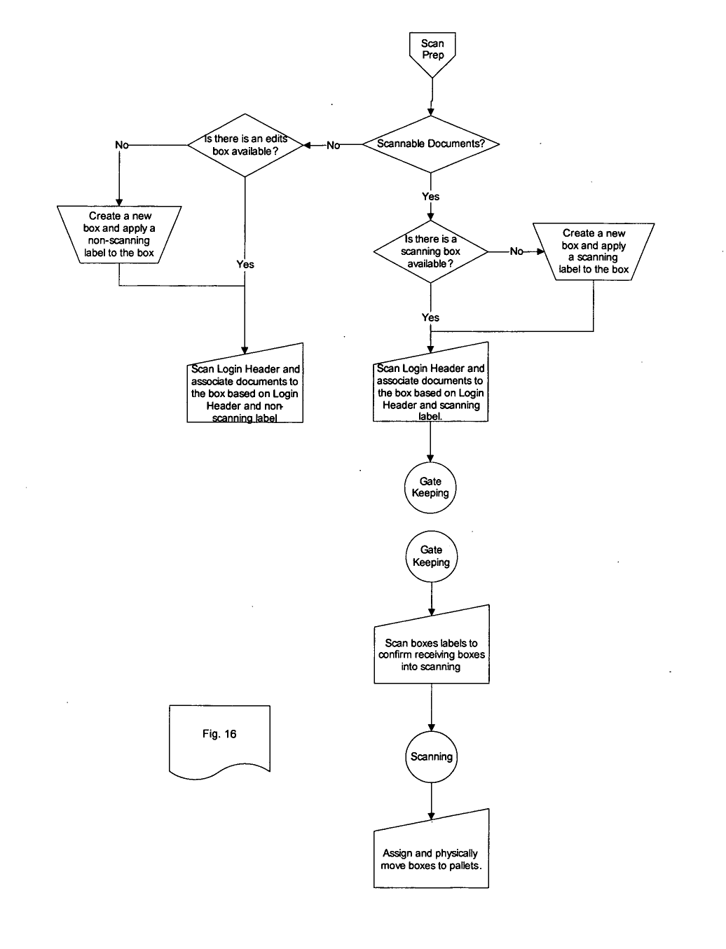

FIG. 15 is a simplified flow chart and logic diagram of the logging in steps of document level materials, preceding the scanning operation of the secure test materials. The login operation compares the record of what documents were shipped to what was returned, with the obvious goal of confirming receipt of all expected documents. Login headers are printed reflecting updates based on the physical inventory of returned materials. This “one touch” initiative of applying essentially real time edits at every stage to flaws and errors in form and content of the returned materials during the pre-scan processing is important for maintain the efficiency of the down stream scanning and scoring processes.

Pre-login sorts used answer documents from unused and test booklets. Full page images of all test booklets and all unused answer documents are made and warehoused for possible reference. Login also captures static and variable barcodes of each test booklet, secure administrative materials and each unused answer document. OMR camera and human review if a barcode identifier is defaced or if a used answer document was mistaken for an unused package. All physical materials are kept for months, but all processing is normally done with imagers once login and scanning are complete. Images are retained on all secure materials.

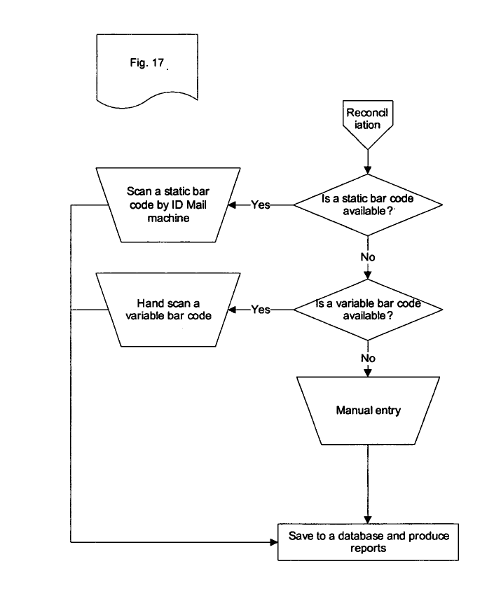

FIG. 16 is a simplified flow chart and logic diagram of the scanning preparation steps, batching or boxing of like documents, gate keeping, and scanning of secure test materials including headers, test materials identifiers, test documents, and individual answer pages. Scanning of the login header or the identifier of any document assigned to a particular scanning box will preset the document processing system and image processing application to the applicable rules. The operator then enters the login label then individual answer documents for scanning and full page conversion to images, each for which the system creates an identifier and associates to a test booklet.

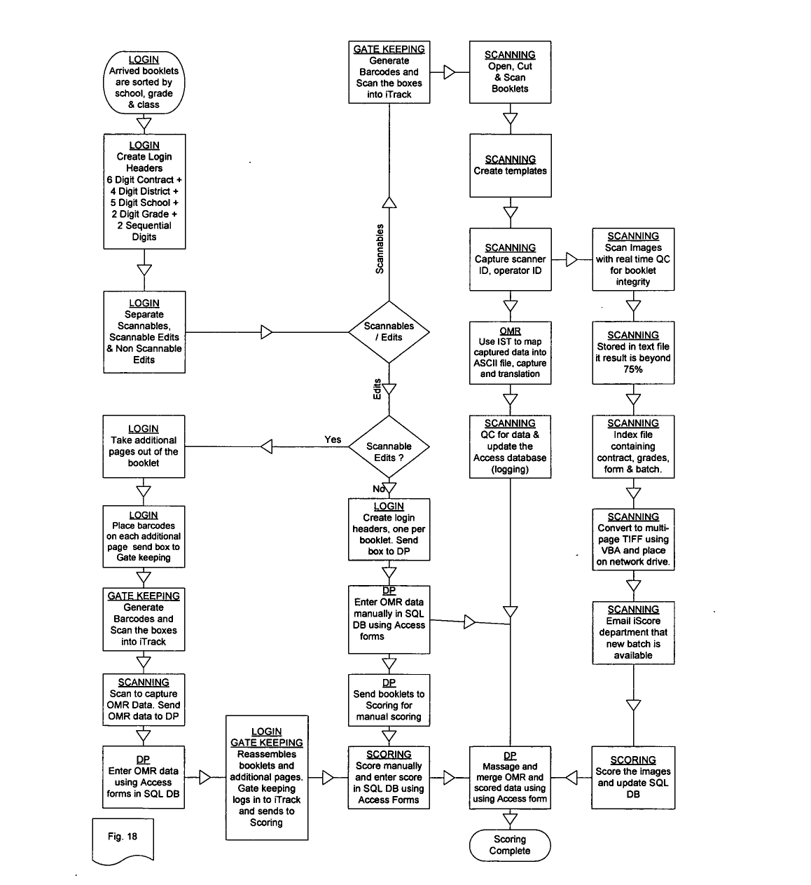

FIG. 17 is a simplified flow chart and logic diagram of the steps for reconciling materials for which identifiers were not scanned or matched successfully to existing database information. Hand scanning or manual entry are alternatives to normal machine/document scanning.

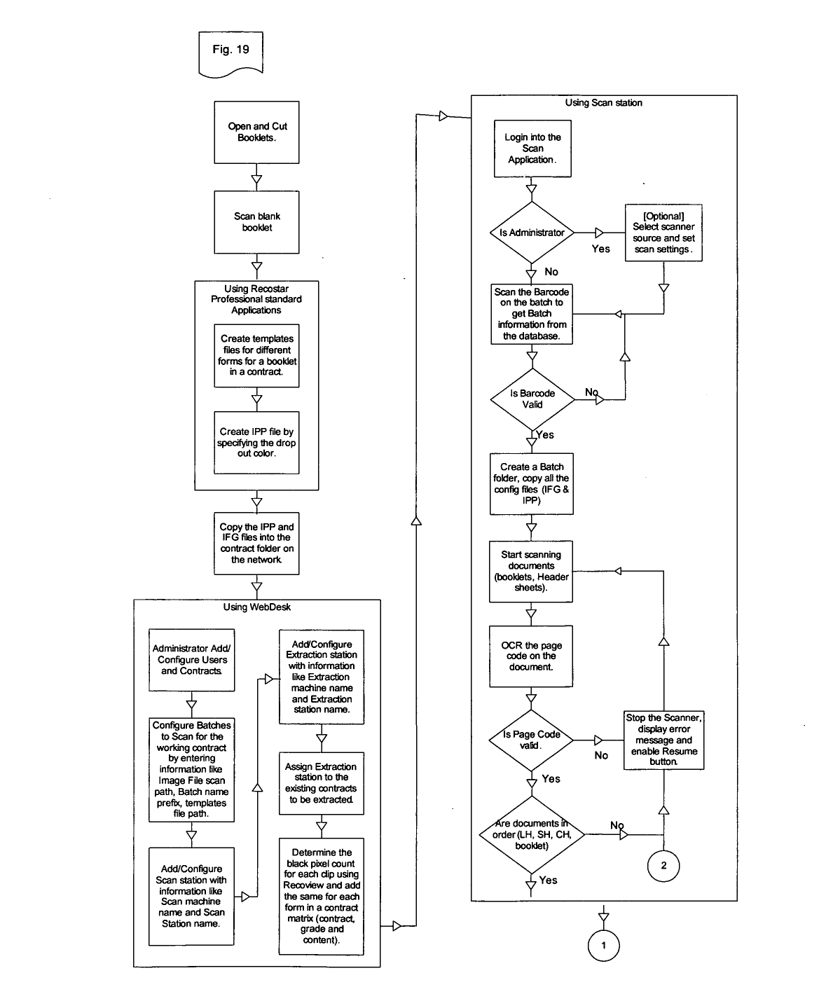

FIG. 18 is a simplified flow chart and logic diagram of one embodiment scanning process connecting the logging in of returned test booklets through gate keeping to extraction of OMR data, whole page scanning of pages, sending a mirror image to data warehouse, and template driven extraction/clipping of selected answer areas for reading data “bubbles” from scanned image, and whole page extraction of open response answer areas, to scoring of component portions of answer documents, compilation of component scores to a final score. Initially the first scan is done in color JPEG format, then OMR (optical mark recognition) and IST. VBA means visual basic. Scannable edits refers to mutilated documents, which require fixing of the identifier to keep it moving.

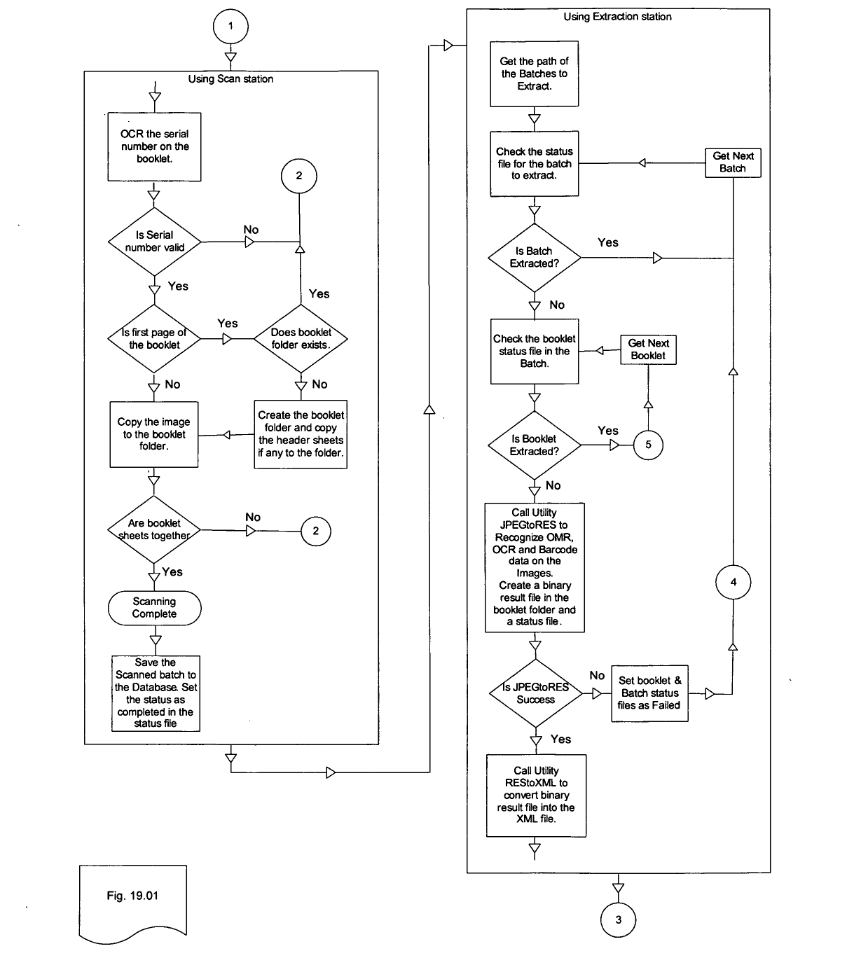

FIGS. 19, 19.01, and 19.02 are a more detailed flow chart and logic diagram of the previous figures relating to the login and scanning components of the invention, extending from opening and cutting of booklets in order to access the pages, and scanning of a blank booklet in this manner for creating scanning templates, to extraction of clipped images for scoring. IS (Information System) Administrator, FIG. 19, is the setup administrator. Electronic identification of specific items can trigger an event, including a human intervention. LH, SH, and CH refer to login headers, school headers, and class headers.

The scanning component is able to read and identify blank areas on open responses, based on black pixel count. Information extracted from images is not written to flat asciiII, comma delimited files; rather data is transferred directly to sequel files which require no further conversion.

Reading pixels for pixel density indicating marks may be selectively done in either a bi-tonal (B&W) mode, which is quicker, or to gray scale—providing potentially far greater resolution at similar scanned pixel densities.

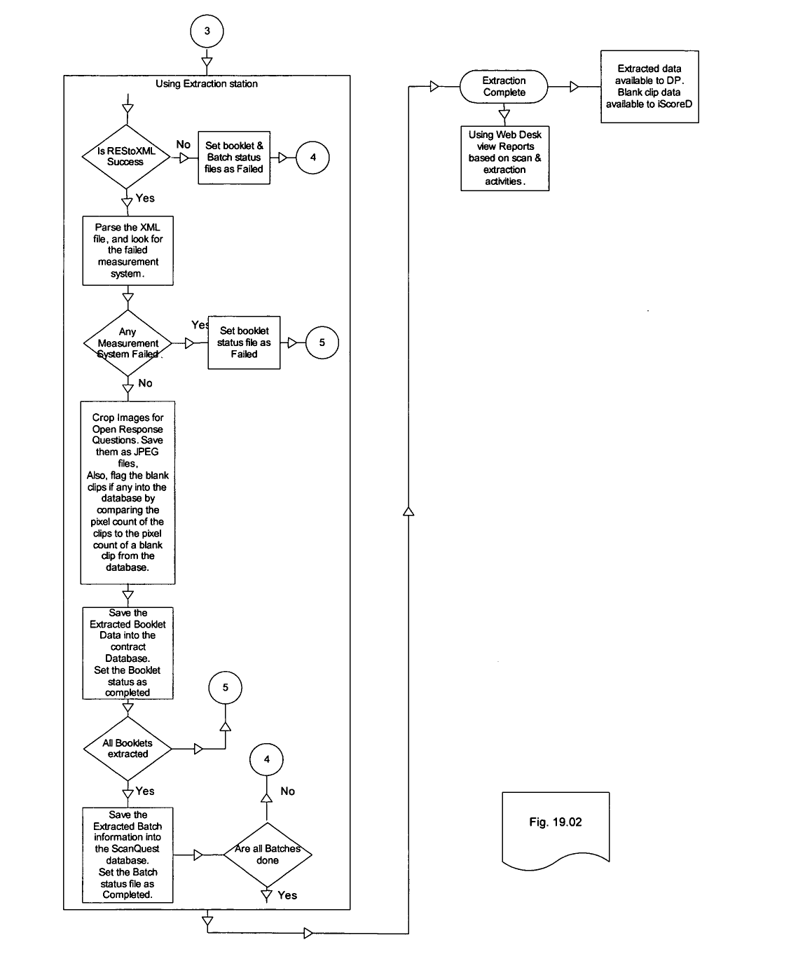

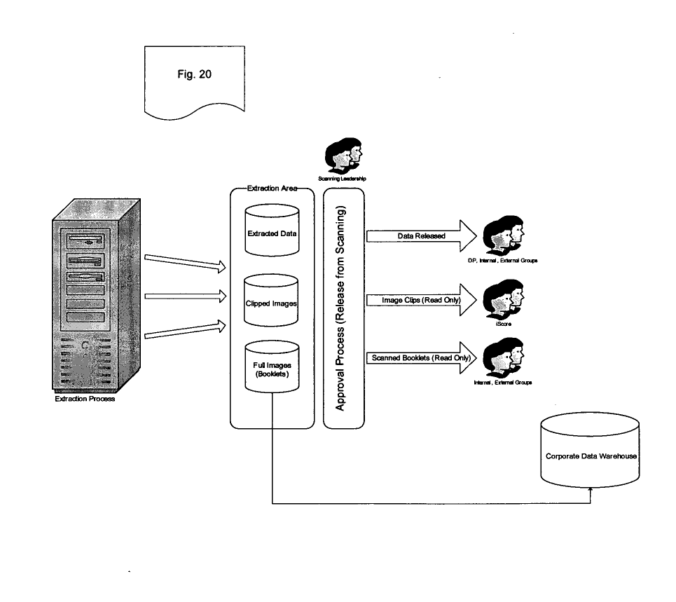

FIG. 20 is a diagrammatic representation of the image storage and retrieval organization and functionality of one embodiment scanning and image servicing component of the invention for scoring activities. The database offers the extracted data, which is machine scored, and clipped images and full images for read-only viewing and scoring by scorers.

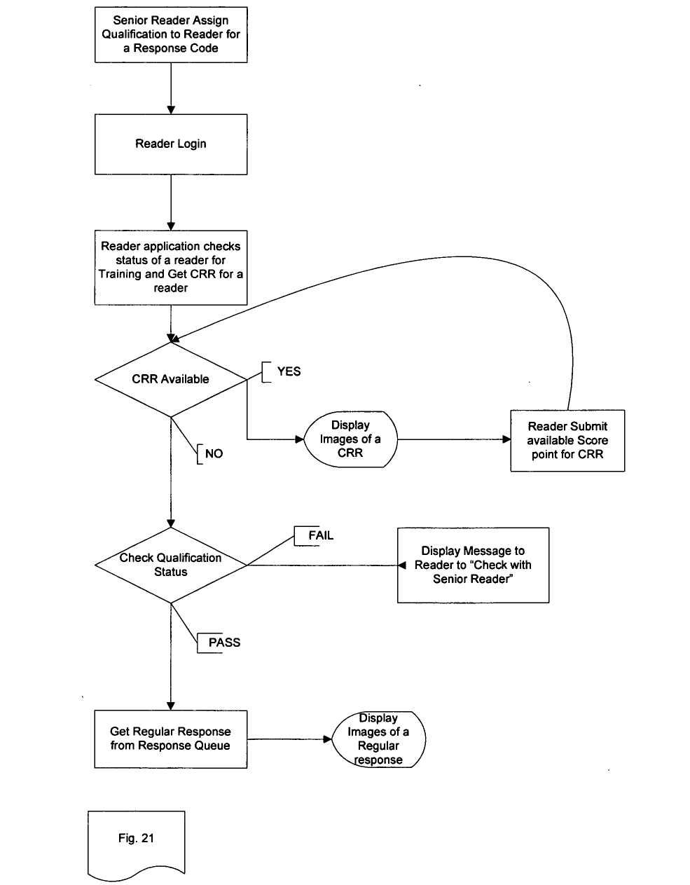

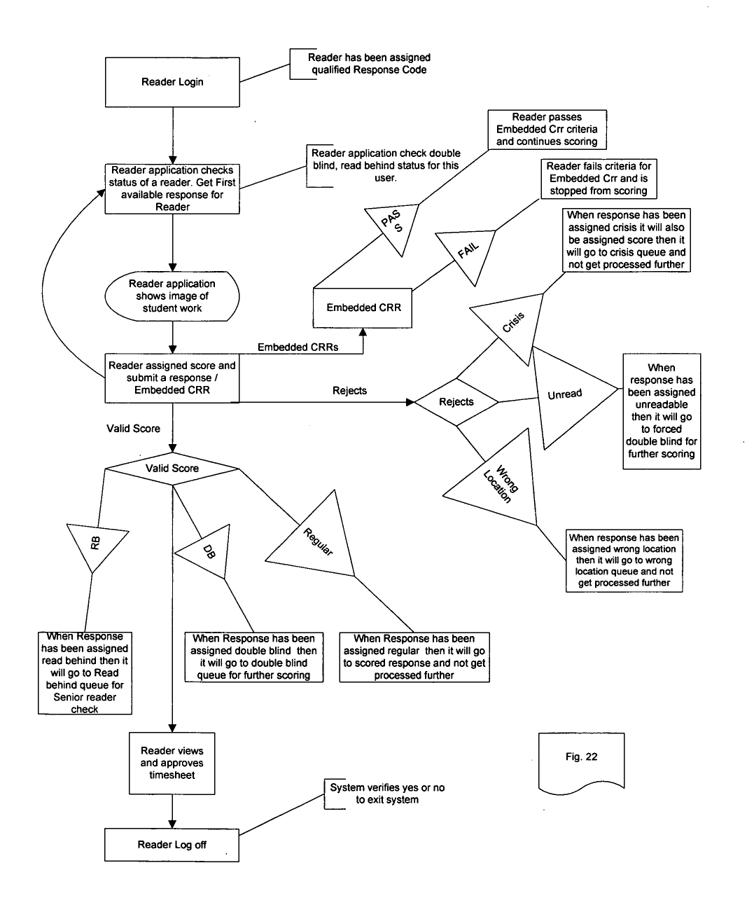

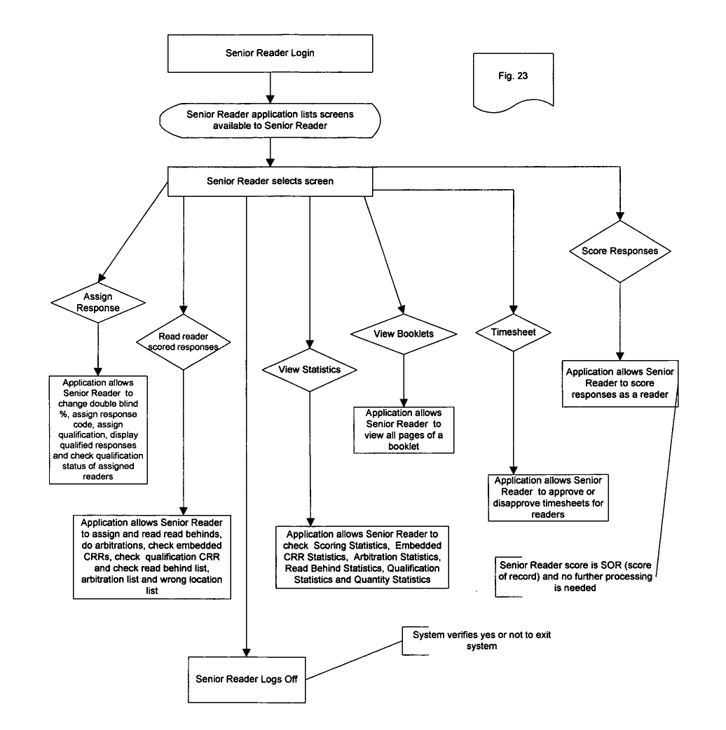

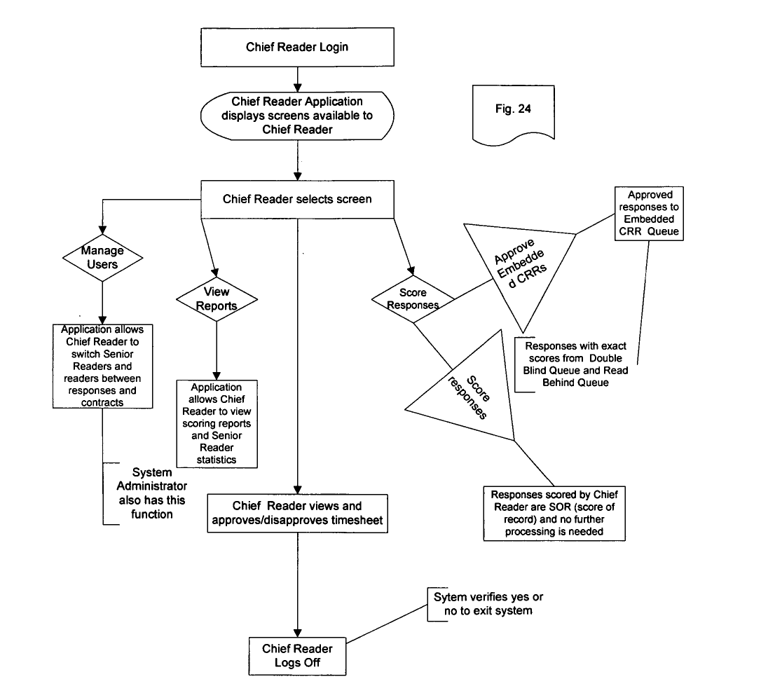

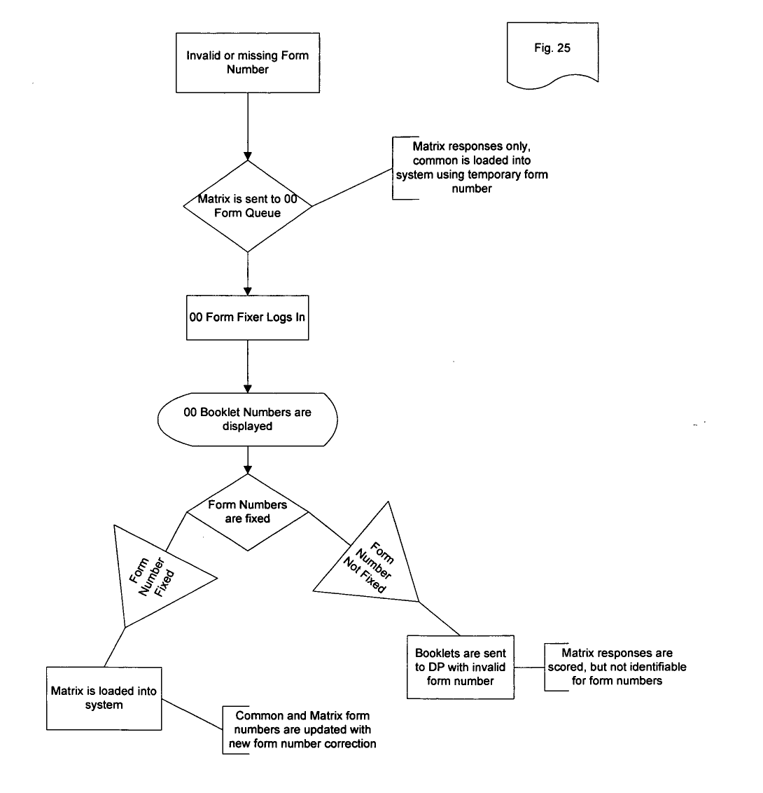

FIG. 21 is a simplified flow chart and logic diagram of a CRR qualification process of readers for the scoring process and component of the invention. Scoring consistency is facilitated by use of CRR's (Committee Rated Response) when available. FIG. 22 is a simplified flow chart and logic diagram of a regular scoring reader's workflow within the scoring process of the invention, illustrating the use of embedded CRR's as a real time quality control tool integrated into the scoring process. RB means read behind. DB means Double Blind. FIG. 23 is a simplified flow chart and logic diagram of a senior reader's workflow within the scoring process of the invention. FIG. 24 is a simplified flow chart and logic diagram of a chief reader's workflow within the scoring process of the invention. FIG. 25 is a simplified flow chart and logic diagram depicting a forms flow within the scoring process of the invention, providing for the circumstance when the form component of a document identifier is flawed or unreadable and resolution of the form type is required for normal processing. There may be multiple forms for any test. Matrix items orientation or placement can vary between forms. Different forms may carry different non-scored questions.

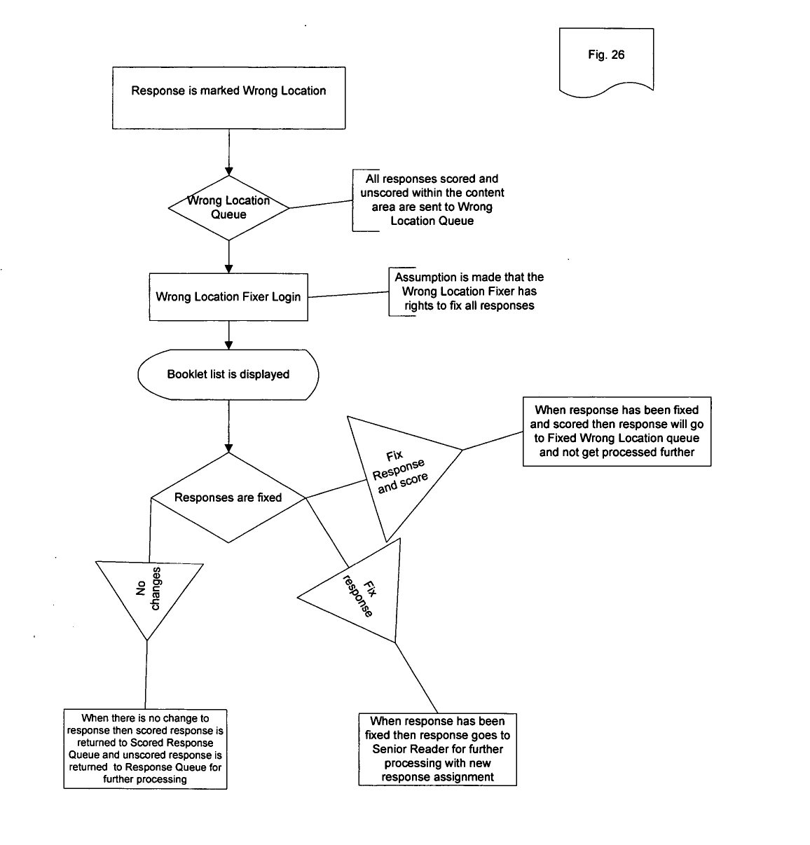

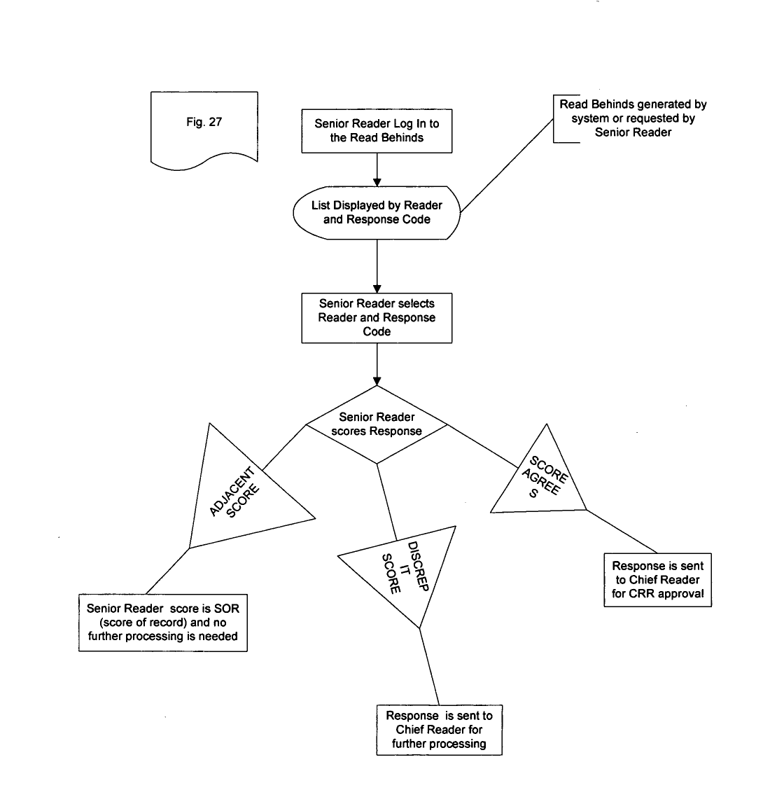

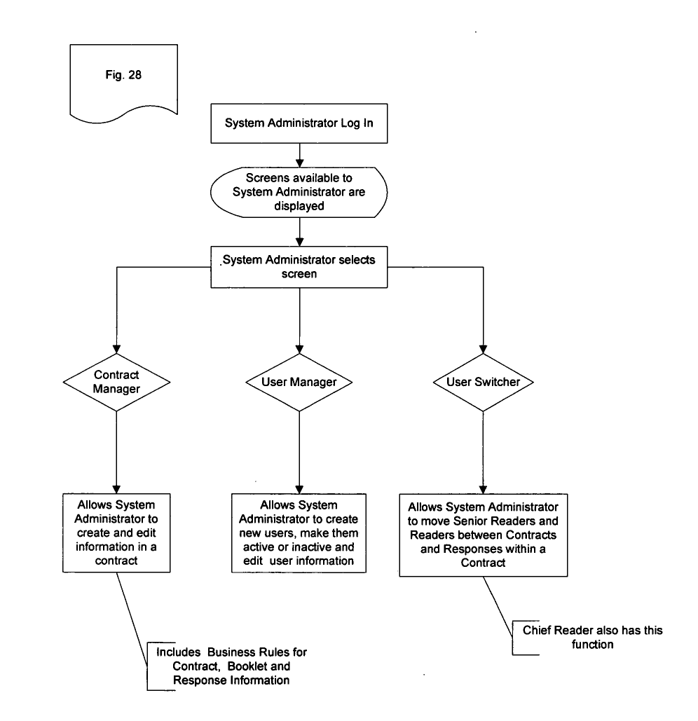

FIG. 26 is a simplified flow chart and logic diagram depicting the handling of a response marked in a wrong location within a scoring process of the invention. FIG. 27 is a simplified flow chart and logic diagram depicting the work flow for responses designated for “read behinds” after initial scoring, within the scoring process of the invention. FIG. 28 is simplified flow chart and logic diagram depicting the workflow and management hierarchy of a scoring system administrator within the scoring process of the invention.

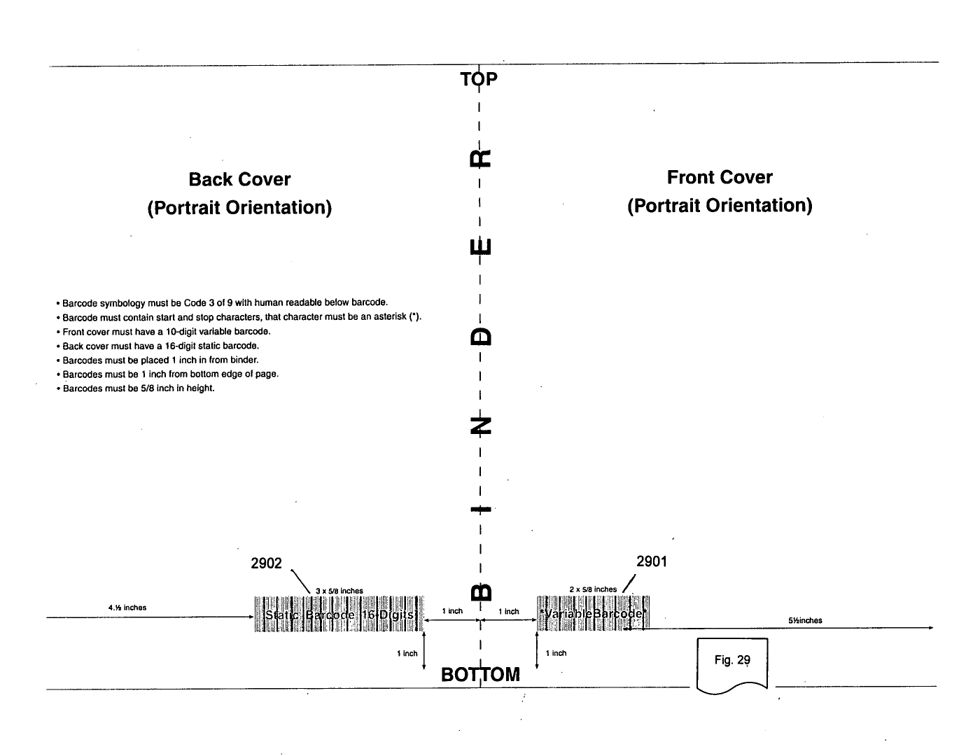

FIG. 29 is a sample illustration of a test booklet template providing locator information for placement of a static barcode identifier component relating to the type document, contract, grade, content area and form number, and a unique or variable barcode item identifier component with a grade and form number embedded in it. As part of being able to track these materials in the manner required, each item of the materials must be made distinguishable in all ways relevant to the process. Referring again to FIG. 29, the test booklet template illustrates the placement of variable barcode identifier 2901 and static value barcode identifier 2902 that carry information as described below.

The static barcode 2902 consists of possible 14-16 characters, which are divided into 6 fields. The fields are listed in Table 1:

TABLE 1

| | Character |
|---|---|
| Field Name | Position |
| Document type | 0-1 |
| Document | 2-3 |
| Subtype | |
| Contract Number | 4-7 |
| Grade Level | 8-9 |
| Content Area | 10-11 |
| Form Number | 12-13 |
| Version | 14-15 |

An example value for the fields and character positions are shown in Table 2 below:

TABLE 2

| Field | Value | Description |
|---|---|---|
| Document Type | 01 | Answer Document |
| | 02 | Student Test |
| | | Booklet |
| | 03 | Principal |
| | | Certification |
| | 08 | District Header |
| | 08 | School Header |
| | 08 | Class Header |
| | 08 | Teacher Header |
| | 08 | Login Header |
| Contract Number | 9999 | FLA |
| | 8888 | IA |
| | 7777 | NV |
| Grade Level | 21 | First |
| | 22 | Second |
| | 23 | Third |
| | 11 | Eleven |
| | 12 | Twelve |
| Content Area | 00 | Multiple |
| | 01 | Reading |
| | 02 | Math |
| | 06 | Science |
| | 09 | Social Studies |
| | 11 | Health |
| Version | -E | English |
| | -S | Spanish |
| | -L | Large Print |
| | -B | Braille |

The litho (variable serial number) barcode 2901 consists of 10 characters, which are divided in 3 fields as shown in Table 3 below:

TABLE 3

| | Character |
|---|---|
| Field Name | Positions |
| Grade Level | 0-1 |
| Form Number | 2-3 |
| Unique Number | 4-9 |

An example value for the character positions are shown in Table 4 below:

TABLE 4

| Field | Value | Description |
|---|---|---|
| Grade Level | 11 | Grade 1 |
| | 16 | Grade 6 |
| | 20 | Grade 10 |
| Form Number | 03 | Form 3 |
| | 08 | Form 8 |
| Unique Number | 123456 | |
| | 987654 | |

The rule for validating an article of the returned test materials includes a scheme defined as when one or both of the barcodes 2901, 2902 exist on an item of material. If only one barcode exists, the location may reside on the front or back of the booklet and consist of either the static 2902 or litho barcode 2901. If the material does not adhere to the defined scheme, the material is to be rejected and labeled as such, separating it from the materials that conform to the sort scheme. If materials are rejected due to a no-read (NR) during a job run, the system must have the ability to re-run materials in a particular job. If a “good read” occurs on a second attempt, the SQL table must be updated accordingly. When a front and back barcode exists, the front is primary and is read and reported first in the file and for reports. The back is secondary.

It can be seen from this explanation that the key to the system is the extent to which rule driven software can use project data to create unique identifiers in a relational database that represent and link virtual counterparts of all of the required master articles and items of the assessment materials for the project. The rules then project a virtual production schedule for building and shipping the assessment. The rules then extend the virtual system to carry the virtual project through tracking, receiving, log in, scanning, scoring, and reporting operations to completion of the virtual project.

The touch points of the system to the physical world, including interfaces with the host operators, client users and scorers, provide the control and feedback linkages that enable the system to translate its virtual assessment project into a real world operation.

The invention is susceptible of various embodiments. For example, there is a process for conducting an assessment project of testing multiple testees consisting of using an item tracking, database management, and relational database system having a document processing system for exposing articles and individual pages to electronic scanning, a computer network connected to the document processing system and to the internet, and a software program associated with the document processing system and the computer network; where the software program has global business rules, a relational database, a web browser application for host and client interface, and an image processing application associated with the document processing system.

Another step in the process is to store in the relational database a unique project identifier and associated project data; where the project data has project rules, project locations and unique location identifiers, and quantities of testees at each project location. The process generates a master items production quantity requirement which includes each item of assessment materials for the project in accordance with the global business rules and the project data, the items consisting of secure test materials and ancillary test materials, the secure test materials consisting of answer sheets or answer pages susceptible of electronic scanning. The process creates and stores in the relational database a unique item identifier corresponding to each respective item of secure test materials including each sheet containing at least one answer page.

Assessment materials are produced corresponding to the master items production quantity requirement, including producing each item of secure test materials with its respective unique identifier inseparably affixed to it. A production plan for assembly of the assessment materials is generated in accordance with the global business rules and the project data, the plan consisting of using combinations of pre-selected intermediate quantities of the secure test materials and the ancillary test materials for packing shipping containers.

Pre-selected intermediate quantities of the secure test materials are packaged into class packs according to the production plan, each class pack being assigned and labeled with a unique identifier that is stored in the relational database and associated with the unique identifiers of the items of secure test materials within.

Pre-selected intermediate quantities of ancillary materials are packaged into kits according to the production plan such that at least one kit is required at each project location, each kit being assigned and labeled with a unique identifier that is stored in the relational database and associated with the master items within and the quantities thereof.

Selected said kits and said class packs are allocated to specific project locations, and in the relational database the unique identifiers of each class pack and kit are associated with the unique identifier of the respective project location.

Return shipping envelopes are produced and included for each project location for packaging and returning selected items of secure test materials, each envelope being assigned and labeled with a unique identifier which is stored in the relational database and associated therein with the project location identifier and item identifiers of items expected to be returned in them.

Class packs, return shipping envelopes and kits are packed by project location into shipping containers, each container being assigned and labeled with a unique identifier which is stored in the relational database and associated with the unique identifiers of the class packs and kits and return shipping labels within and the respective project location identifier of the project location for which it is intended.

Packed containers are consigned to a shipper for shipping. A shipper's identifier for each container is obtained, which is stored in the relational database and associated therein with the unique identifiers of the respective container and the project location. A notice of shipment including the shipper's identifier for each container is sent to a designated POC at each respective project location.

The shipper is periodically questioned for status of the consigned containers. The responses are recorded in the relational database, and associated with the respective shipper's identifier for each container. Status reports relating to the project are generated on demand.

Secure test materials may consist of multiple forms of test booklets and each form of a test booklet may have a unique form identifier, and each test booklet of the same form may have a unique booklet identifier. The project data may require a particular distribution of the forms of test booklets among different project locations and among the group of testees at each project location.

A schedule for the producing of said test booklets and packaging into said class packs may be generated and stored in the relational database such that the associated forms identifiers are arranged and grouped into a distributed set of form identifiers and test booklet identifiers in class pack quantities, where each set is assigned a class pack identifier which is stored in the relational database and associated with its respective form and test booklet identifiers in their distributed order therein. Test booklets and class packs may be produced according to the schedule, each class pack being labeled with its respective unique identifier.

The class packs may be validated to the schedule by comparing the form and test booklet identifier of test booklets at selected locations within selected class packs to the corresponding schedule of test booklet identifiers at corresponding locations within of the respective set of class pack identifiers in the relational database.

As another example, there is a process for preparing multiple controlled articles of multiple forms for distribution of the articles including a pre-determined scheme of distribution of the forms of the articles among a group of recipients, consisting of the following steps.

A schedule of form identifiers may be generated and stored in a relational database, where each corresponds to a different form of the article. There may be a unique article identifier for each article of the same form in the quantities required, where each type of form identifier is distributed according to the scheme throughout the schedule, and be associated with an article identifier for an article of the same form. Thereafter an arrangement of articles corresponding to the schedule may be produced and so labeled.

Then the correct arrangement of the articles may be validated for proper distribution of the forms of the article by comparing the form and article identifier of articles at selected locations within the arrangement to the corresponding schedule of form and article identifiers at corresponding locations within the schedule. The articles may be produced in sequence and incorporate the form and article identifiers according to the schedule with each article as it is produced.

Approved requests for changes are appended to the relational database so as not to alter previous information, providing an audit track of the data.

As yet another example, there is a process for interpreting whether a specific, visible target or bubble of finite area on a sheet has been manually marked to indicate an intentional response directed at that target or bubble, consisting of making an electronic image of at least a portion of the sheet containing the target, at a scanned pixel density of at least 150 dpi; determining the target location within the image area; superimposing a zone of measurement over the target location wherein the area of the zone of measurement is at least equal to the area of the target and preferable somewhat larger although not so large as to overlap an adjacent bubble or its comparable zone of measurement; then measuring the light density of each pixel within the zone of measurement to a yes or no, black or white pixel resolution. or for more resolution, to a grey scale; then calculating the sum of the light densities of all the pixels in the zone, so as to, in other words, derive the number or percentage of black versus white in the zone; and comparing the sum to a pre-determined threshold light density indicating a mark.

The process may further consist of project data that includes testee identities by project location, and the steps of: creating and storing a unique identifier in the relational database for each testee identity in association with its respective project location; associating in the relational database a secure test materials identifier with each testee identifier; producing a testee set of secure test materials with a respective secure test materials identifier and an associated testee identifier inseparably affixed to it; and packaging the testee sets into class packs, where each class pack contains testee sets intended for a common project location.

An additional example of the invention is a process for preparing multiple controlled articles of multiple forms for distribution of the controlled articles to identified recipients, including a pre-determined scheme of distribution of the forms of the controlled articles among the group of identified recipients, consisting of: generating and storing in a relational database a schedule of form identifiers, each corresponding to a different form of the article, and a unique article identifier for each article of each form in the quantities required, where each type of form identifier is distributed throughout the schedule and associated with an article identifier for an article of the same form; creating and storing a unique identifier in the relational database for each intended recipient of an article; associating each form identifier and associated article identifier in the schedule with a respective recipient identifier; producing and labeling an arrangement of articles according to the schedule; and validating the arrangement of articles for proper distribution of the forms of the article by comparing the form and article identifier of articles at selected locations within the arrangement to the corresponding schedule of form and article identifiers at corresponding locations within of the respective set of identifiers in the relational database.

A further example of the invention is a method for receiving, processing, scoring and reporting on secure test materials returned in an assessment project testing multiple testees, comprising the steps: using a system consisting of a document processing system for exposing documents including individual sheets and pages to electronic scanning, a computer network connected to the document processing system and to the internet, and a software program associated with the document processing system and the computer network; where the software program has global business rules, a relational database, a web browser application for system host and client interface to the system, and an image processing application associated with the document processing system, and where the relational database contains and relates a project identifier to project data and identifiers including project rules, data and identifiers for project locations, data and item identifiers and production requirements on all master items of the secure test materials including all test booklets and other documents containing a test item and all documents having an answer page, the production plan and history for assembly and shipment of said master items, and the tracking history of said secure test materials.

Also including the further steps: maintaining a record of unique identifiers of the secure test materials shipped to project locations and not yet returned; receiving previously shipped assessment materials as returned materials; scanning and comparing the unique identifiers affixed to said returned materials to said record of said materials shipped; updating the record of said materials shipped; reducing packages of returned materials to sheets of secure test materials; and scanning each page of secure test materials and storing an image thereof in a data warehouse in association with its page identifier.

Also including the further steps: pre-selecting scanning procedures for the document processing system and the image processing application by reference to a returned item identifier; scanning and storing an answer page image of each answer page of the secure test materials in the relational database in association with its respective answer page identifier; associating each used answer page with a respective test booklet; extracting answer information from said images of said answer pages; converting the answer information into raw scores; compiling the raw scores into a final score for all answer pages associated with each used said test booklet, and hence with each associated testee;

Compiling final scores for each testee by project location; and generating project reports based on the final scores.

Also, the process may include the steps of: incorporating unique identifiers with items of assessment materials in the form of an RFID chip programmed with at least a unique identifier associated with the respective said item; reading the unique identifiers by means of bringing assessment materials within range of an RFID signal receiver and initiating an RFID chip transmission, where the RFID receiver communicates received information with the system. The RFID chip may be further programmed with processing instructions.

Further embodiments of the invention may include the steps: automated reviewing of each specific answer area of each said answer page image; automated detecting of the absence of a testee input in a specific answer area; automated recording in the relational database of the absence of a testee input associated with the specific answer page area of the related answer page; and automated withholding from scorers the specific answer area of the answer page image.

Furthermore, another example of the invention is a system for conducting large scale test and assessment projects consisting of a relational database having of a core database of global rules and project data, a tracking database, a scanning and image management database, and a scoring database; a software program and computer network connected to the relational database, a web interface linking the software program and computer network to host and client users, where the software program and relational database are configured for generating a production requirement of master items and a packing schedule of master items from the rules and the project data, and for tracking the packing and shipping of the master items, tracking the return and scanning of secure master items, meaning those items intended to be returned and accounted for, scanning and scoring the answer pages and parts of the returned master items, and reporting on the resulting scores.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

1. A process for conducting an assessment project of testing multiple testees comprising the steps of:
using a system comprising a document processing system for exposing articles and individual pages to electronic scanning, a computer network connected to the document processing system and to the internet, and a software program associated with said document processing system and said computer network; said software program comprising global business rules, a relational database, a web browser application for host and client interface, and an image processing application associated with said document processing system;
storing in said relational database a unique project identifier and associated project data; said project data comprising project rules, project locations and unique location identifiers, and quantities of testees at each said project location;
generating a master items production quantity requirement which includes each item of assessment materials for said project in accordance with said global business rules and said project data, said items comprising secure test materials and ancillary test materials, said secure test materials comprising sheets of answer pages susceptible of electronic scanning;
creating and storing in said relational database a unique item identifier corresponding to each respective item of secure test materials including each sheet containing at least one answer page;
producing said assessment materials corresponding to said master items production quantity requirement, including producing each said item of secure test materials with its respective said unique identifier inseparably affixed thereto;
generating a production plan for assembly of said assessment materials in accordance with said global business rules and said project data, said plan comprising using combinations of pre-selected intermediate quantities of said secure test materials and said ancillary test materials for packing shipping containers;
packaging said pre-selected intermediate quantities of said secure test materials into class packs according to said production plan, each said class pack being assigned and labeled with a unique identifier which is stored in said relational database and associated with the unique identifiers of the items of secure test materials within;
packaging said pre-selected intermediate quantities of said ancillary materials into kits according to said production plan such that at least one kit is required at each said project location, each said kit being assigned and labeled with a unique identifier which is stored in said relational database and associated with the master items within and the quantities thereof;
allocating selected said kits and said class packs to specific project locations, and associating in said relational database the unique identifiers of each said class pack and said kit with the unique identifier of the respective project location;
producing and including return shipping envelopes for each said project location for packaging and returning selected said items of secure test materials, each said envelope assigned and labeled with a unique identifier which is stored in said relational database and associated therein with the project location identifier and item identifiers of items expected to be returned therein;
packing said class packs, said return shipping envelopes and said kits by project location into said shipping containers, each said container being assigned and labeled with a unique identifier which is stored in said relational database and associated with the unique identifiers of the class packs and kits and return shipping labels within and the respective project location identifier of the project location for which it is intended;
consigning said containers to a shipper for shipping, obtaining therefrom a shipper's identifier for each said container which is stored in said relational database and associated therein with the unique identifiers of the respective said container and the project location;
sending a notice of shipment including the shipper's identifier for each said container to a designated POC at each respective project location;
periodically querying said shipper for status of said containers consigned, recording responses in said relational database, and associating said responses with respective said shipper's identifier for each said container; and
generating on demand, status reports relating to said project.

2. The process according to claim 1, wherein said secure test materials comprise multiple forms of test booklets and each said form of a test booklet has a unique form identifier and each said test booklet of the same form has a unique booklet identifier, said project data requires a particular distribution of said forms of test booklets among project locations and among the group of testees at each said project location, comprising the further steps:
generating and storing in said relational database a schedule for the producing of said test booklets and packaging into said class packs wherein the associated forms identifiers are arranged and grouped into a distributed set of form identifiers and test booklet identifiers in class pack quantities, each said set being assigned a class pack identifier which is stored in said relational database and associated with its respective said form and test booklet identifiers and their distributed order therein;
producing said test booklets and said class packs according to said schedule, each said class pack being labeled with its respective unique identifier;
validating said class packs to said schedule by comparing the form and test booklet identifier of test booklets at selected locations within selected class packs to the corresponding schedule of test booklet identifiers at corresponding locations within of the respective set of class pack identifiers in said relational database.

3. The process of claim 1, said step of producing said assessment materials corresponding to said master items production quantity requirement, including producing each said item of secure test materials with its respective said unique identifier inseparably affixed thereto, comprising producing test booklets in sequence and incorporating a respective unique identifier with each said test booklet as it is produced.

4. A process for preparing multiple controlled articles of multiple forms for distribution of the articles including a pre-determined scheme of distribution of the forms of the articles among a group of recipients, comprising the steps:
generating and storing in a relational database a schedule of form identifiers, each corresponding to a different said form of the article, and a unique article identifier for each article of the same form in the quantities required, where each type of form identifier is distributed according to said scheme throughout the schedule and associated with a said article identifier for an article of the same form.
producing and labeling an arrangement of articles corresponding to said schedule;
validating the correct arrangement of said articles for proper distribution of said forms of said article by comparing the form and article identifier of articles at selected locations within said arrangement to the corresponding schedule of form and article identifiers at corresponding locations within the schedule.

5. The process of claim 4, the step of producing, arranging and labeling said articles according to said schedule comprising
producing said articles in sequence and incorporating said form and article identifiers according to said schedule with each said article as it is produced.

6. The process of claim 1, comprising the steps of:
receiving requests for changes;
evaluating according to global business rules and project data all said requests for at least one of requestor's authority, format of request, items authorized, and quantities authorized;
approving or refusing said requests;
appending any approved said requests in said relational database to original project data and production requirements and any prior approved requests such that original project data and original production requirements and all changes thereto are preserved in said relational database; and
updating the current in-use project data and production requirements to be the summation of the original project data and production requirements plus all approved changes thereof.

7. The process of claim 6, the step of receiving requests for changes comprising receiving online interactive requests for changes.

8. The process of claim 6, said step of refusing or approving comprising:
refusing requests for shipments of additional materials to a project location if no acknowledgement of receipt of prior shipments has been received.

9. A process for interpreting whether a specific, visible target of finite area on a sheet has been manually marked to indicate an intentional response directed at that target, comprising the steps
making an electronic image of at least a portion of the sheet containing the target at a scanned pixel density of at least 150 dpi;
determining the target location within the image area;
superimposing a zone of measurement over the target location wherein the area of said zone of measurement is at least equal to the area of said target;
measuring the light density of each pixel within the zone of measurement;
calculating the sum of said light densities of all said pixels within the zone; and
comparing the sum to a pre-determined threshold light density indicating a mark.

10. The process of claim 6, further comprising the steps of:
permitting on-line system access and real time monitoring and audit control of said project data and said production requirements and requested changes thereto.

11. The process of claim 1, further comprising the steps:
recording, uploading and comparing the container, kit and class pack identifiers received at said project locations with corresponding identifiers in said relational database to confirm delivery of intended materials.

12. The process of claim 11, further comprising the steps:
distributing said assessment materials to said testees;
assuring that the particular secure materials used by each testee are marked with its testee identity;
conducting testing of said testees whereby testee responses to test items within its secure test materials are entered on the respective answer pages;
collecting, repacking and reshipping at least said secured test materials using said return shipping labels to the system host for processing; and
providing notice to said system of said reshipping.

13. The process of claim 1, said steps further comprising:
using a scanner at a project location,
scanning assessment materials at said project location; and
connecting said scanner to said system via said on-line internet access for uploading of scanned information.

14. The process of claim 1, said system further comprising hand held scanners.

15. The process of claim 14, said scanners being connectible to said system by wireless means.

16. A process according to claim 1, said project data further comprising testee identities by project location, comprising the further steps:
creating and storing a unique identifier in said relational database for each said testee identity in association with its respective project location;
associating in said relational database a said secure test materials identifier with each said testee identifier;
producing a testee set of said secure test materials with a respective said secure test materials identifier and associated testee identifier inseparably affixed thereto;
packaging said testee sets into said class packs, each said class pack containing testee sets for a common project location.

17. A process for preparing multiple controlled articles of multiple forms for distribution of the controlled articles to identified recipients, including a pre-determined scheme of distribution of the forms of the controlled articles among the group of identified recipients, comprising the steps:
generating and storing in a relational database a schedule of form identifiers, each corresponding to a different said form of the article, and a unique article identifier for each article of each form in the quantities required, where each type of form identifier is distributed throughout the schedule and associated with a said article identifier for an article of the same form
creating and storing a unique identifier in said relational database for each intended said recipient of said articles;
associating each said form identifier and associated said article identifier in said schedule with a respective said recipient identifier;
producing and labeling an arrangement of said articles according to said schedule;
validating the arrangement of said articles for proper distribution of said forms of said article by comparing the form and article identifier of articles at selected locations within said arrangement to the corresponding schedule of form and article identifiers at corresponding locations within of the respective set of identifiers in said relational database.

18. A method for receiving, processing, scoring and reporting on secure test materials returned in an assessment project testing multiple testees, comprising the steps:
using a system comprising a document processing system for exposing documents including individual sheets and pages to electronic scanning, a computer network connected to the document processing system and to the internet, and a software program associated with said document processing system and said computer network; said software program comprising global business rules, a relational database, a web browser application for system host and client interface to said system, and an image processing application associated with said document processing system, said relational database containing and relating a project identifier to project data and identifiers including project rules, data and identifiers for project locations, data and item identifiers and production requirements on all master items of the secure test materials including all test booklets and other documents containing a test item and all documents having an answer page, the production plan and history for assembly and shipment of said master items, and the tracking history of said secure test materials;
maintaining a record of unique identifiers of said secure test materials shipped to project locations and not yet returned;
receiving previously shipped assessment materials as returned materials;
scanning and comparing the unique identifiers affixed to said returned materials to said record of said materials shipped;
updating said record of said materials shipped;
reducing packages of said returned materials to sheets of secure test materials;
scanning each page of secure test materials and storing an image thereof in a data warehouse in association with its page identifier;
pre-selecting scanning procedures for said document processing system and said image processing application by reference to a returned item identifier;
scanning and storing an answer page image of each answer page of said secure test materials in said relational database in association with its respective said answer page identifier;
associating each used said answer page with a respective test booklet;
extracting answer information from said images of said answer pages;
converting said answer information into raw scores;
compiling said raw scores into a final score for all answer pages associated with each used said test booklet, and hence with each associated said testee;
compiling final scores for each said testee by project location; and
generating project reports based on said final scores.

19. The process of claim 1, comprising the further step:
incorporating unique identifiers with items of assessment materials in the form of an RFID chip programmed with at least a unique identifier associated with the respective said item;
reading said unique identifiers by means of bringing said assessment materials within range of an RFID signal receiver and initiating an RFID chip transmission, said RFID receiver communicating received information with said system.

20. The method of claim 18, comprising the further step:
wherein unique identifiers were incorporated with items of assessment materials in the form of an RFID chip programmed with at least a unique identifier associated with the respective said item;
reading said unique identifiers by means of bringing said assessment materials within range of an RFID signal receiver and initiating an RFID chip transmission, said RFID receiver communicating received information with said system.

21. The process of claim 19, said RFID chip being further programmed with processing instructions.

22. The process of claim 20, said RFID chip being further programmed with processing instructions.

23. The method of claim 18, said steps of extracting answer information from said answer page images; and converting said answer information into raw scores comprising:
distributing each said answer page image or an associated portion thereof among a group of scorers, each said scorer having an associated unique scorer identifier;
presenting selected said images for viewing in sequence to each scorer for scoring,
recording a raw score entered by said scorer as each image is viewed; and
associating said raw score with the said image identifier of the respective viewed image and with the scorer identifier of said scorer in said relational database.

24. A method according to claim 23, said step of presenting selected said images in sequence to each scorer comprising
caching images in said sequence subsequent to the current viewed image such that any interruption in the scorer's station, program or network results in the dropping of cached said images.

25. The method of claim 18, said steps of extracting answer information from said images of said answer pages; and converting said answer information into raw scores comprising:
creating clipped images by use of a template of areas of said answer page image containing designated answer targets intended for selective marking by a testee in response to instructions and test items;
determining the pattern of targets marked by automated scanning of said target zones; and
comparing said pattern of targets marked to an associated schedule of possible patterns of targets marked and related range of raw scores in said relational database.

26. The method of claim 25, said step of determining the pattern of targets marked comprising the steps:
superimposing a zone of measurement over each target location within the clipped image area wherein the area of said zone of measurement is at least equal to the area of said target;
measuring the light density of each pixel within the zone of measurement;
calculating the sum of said light densities of all said pixels within the zone; and
comparing the sum to a pre-determined threshold light density indicating a mark.

27. A process according to claim 1, said unique identifiers comprising bar-codes, said scanning said identifiers comprising laser scanning, zone optical character recognition and live video encoding (LVE) of said bar-codes.

28. A process according to claim 1, comprising the further steps
associating a unique testee identifier with respective testee identity and demographic data in said relational database; and
providing on-line internet access to selected parties for review and revision of said testee demographic data.

29. A process according to claim 28, comprising the further step
adding additional testee identities and related demographic data to said relational database; thereby creating respective additional unique testee identifiers associated with said additional testees in said relational database.

30. A process according to claim 28, comprising the further steps:
assigning a particular test booklet to a particular testee for testing; and
associating the related test booklet identifier with the related testee identifier in said relational database.

31. A process according to claim 28, comprising the further steps:
associating a particular test booklet identifier with a particular testee identifier in said relational database; and
matching the related test booklet to the related testee for testing.

32. A process according to claim 29, said step of adding additional testee identities comprising the steps:
producing and packing a pre-selected overage of secure test materials with initial shipments to each said project location, said overage of secure test materials having respective available identifiers recorded in said rational database for later association with a testee identifier;
adding additional testees in said relational database after initial shipments have shipped;
associating each related said additional testee identifier with said available identifiers of said overage of secure test materials in said relational database;
creating at said project location a corresponding identifier label for each said additional testee; and
attaching said identifier label to the corresponding said secure test materials.

33. A process according to claim 1, said software program employing extended markup language (XML) for electronic data interchange.

34. A method according to claim 18, said process further comprising the steps:
automated reviewing of each specific answer area of each said answer page image;
automated detecting of the absence of a testee input in said specific answer area;
automated recording in said relational database of the said absence of a testee input associated with said specific answer page area of said related answer page; and
automated withholding from said scorers of said specific answer area of said answer page image.

35. A method according to claim 18, said image processing application comprising a scalable image capture and image generation sub system.

36. A method according to claim 18, said document processing system and said software program comprising in combination capability for automated indexing in said relational database of said images according to specific attributes in order to facilitate retrieval of said images on the basis of said selected attributes.

37. A method according to claim 36, comprising the further step:
extracting said index information from said images using any of zone optical character recognition, OMR, bar code, and ICR techniques.

38. A method according to claim 18, said image processing application and said software program in combination comprising the use of pipe functions where output from a first command is the input for a subsequent command.

39. A method according to claim 18, comprising the further step of
transferring extracted said answer information directly to pre-defined sequel data files.

40. A method according to claim 18, said step of generating project reports comprising:
extracting testee scores from said relational database; and
populating a pre-defined report template in a specific sequence.

41. A process for conducting an assessment project of testing multiple testees comprising the steps of:
using a system comprising a document processing system for exposing articles and individual pages to electronic scanning, a computer network connected to the document processing system and to the internet, and a software program associated with said document processing system and said computer network; said software program comprising global business rules, a relational database, a web browser application for host and client interface, and an image processing application associated with said document processing system;
storing in said relational database a unique project identifier and associated project data; said project data comprising project rules, project locations and unique location identifiers, and quantities of testees at each said project location;
generating a master items production quantity requirement which includes each item of assessment materials for said project in accordance with said global business rules and said project data, said items comprising secure test materials, said secure test materials comprising test booklets and answer pages susceptible of electronic scanning;
creating and storing in said relational database a unique test booklet identifier corresponding to each respective said test booklet and a unique answer page identifier corresponding to each respective answer page;
producing said assessment materials corresponding to said master items production quantity requirement, including producing each said test booklet and answer page with their respective said unique identifiers inseparably affixed thereto;
generating a production plan for assembly of said assessment materials in accordance with said global business rules and said project data, said plan comprising using combinations of pre-selected intermediate quantities of said test booklets and said answer pages for packing shipping containers;
packaging said pre-selected intermediate quantities of said secure test materials into class packs according to said production plan, each said class pack being assigned and labeled with a unique identifier which is stored in said relational database and associated with the unique identifiers of the items of secure test materials within;
allocating selected said class packs to specific project locations, and associating in said relational database the unique identifiers of each said class pack with the unique identifier of the respective project location;
producing and including return shipping envelopes for each said project location for packaging and returning selected said items of secure test materials, each said envelope assigned and labeled with a unique identifier which is stored in said relational database and associated therein with the project location identifier and item identifiers of items expected to be returned therein;
packing said class packs said return shipping envelopes by project location into said shipping containers, each said container being assigned and labeled with a unique identifier which is stored in said relational database and associated with the unique identifiers of the class packs and return shipping labels within and the respective project location identifier of the project location for which it is intended;
consigning said containers to a shipper for shipping, obtaining therefrom a shipper's identifier for each said container which is stored in said relational database and associated therein with the unique identifiers of the respective said container and the project location;
sending a notice of shipment including the shipper's identifier for each said container to a designated POC at each respective project location;
periodically querying said shipper for status of said containers consigned, recording responses in said relational database, and associating said responses with respective said shipper's identifier for each said container; and
generating on demand, status reports relating to said project.

42. A system for conducting large-scale test and assessment projects comprising
a relational database consisting of a core database of global rules and project data, a tracking database, a scanning and image management database, and a scoring database;
a software program and computer network connected to said relational database, a web interface linking said software program and computer network to host and client users, said software program and said relational database configured for generating a production requirement of master items and a packing schedule of said master items from said rules and said project data, and for tracking the packing and shipping of said master items, tracking the return and scanning of secure said master items, scanning and scoring said secure said master items, and reporting on the resulting scores.
